(19) United States
(12) Patent Application Publication
(10) Pub. No.: US 2016/0293044 A1
(43) Pub. Date: Oct. 6, 2016

(54) SYSTEM AND METHOD FOR ENABLING A USER TO OVERCOME IMPATIENCE LAZINESS AND LOW TRUST ISSUES

(71) Applicants: Jonnalagadda Sasidhar, Sleepy Hollow, NY (US); Gopi Ambikapathi Ambekar, Bangalore (IN); Shilpa Kuppahalli SRINATH, Bangalore (IN); Pranav Kumar MISHRA, Burdwan (IN); Akshatha KINI, Bengaluru (IN); Sreenidhi SUNDARAN, Bangalore (IN)

(72) Inventors: Jonnalagadda Sasidhar, Sleepy Hollow, NY (US); Gopi Ambikapathi Ambekar, Bangalore (IN); Shilpa Kuppahalli SRINATH, Bangalore (IN); Pranav Kumar MISHRA, Burdwan (IN); Akshatha KINI, Bengaluru (IN); Sreenidhi SUNDARAN, Bangalore (IN)

(73) Assignee: DHARMA LIFE SCIENCES LLC, Sleepy Hollow, NY (US)

(21) Appl. No.: 15/182,633

(22) Filed: Jun. 15, 2016

Related U.S. Application Data
(63) Continuation-in-part of application No. 14/931,868, filed on Nov. 4, 2015.

(51) Int. Cl. G09B 19/00; A63F 13/79; G09B 5/02

(52) U.S. Cl. CPC G09B 19/00; G09B 5/02; A63F 13/79

(57) ABSTRACT

A system is provided for enabling a user to overcome impatience, laziness and low trust issues. The system is configured to receive input indicating the desire to overcome at least one of impatience, laziness and low trust issues. The system is configured to enable the user to engage in a first and a second activity in a virtual environment, directed to rewire a first and a second defective wiring respectively. Symptoms of the first and the second defective wirings is at least one of impatience, laziness and low trust issues. Engagement in the second activity is enabled after the user has at least participated in the first activity. Automated instructions are provided to the user to engage in activities performed in a real world environment directed to rewire the first and the second defective wiring.

### CROSS REFERENCE TO RELATED APPLICATION

This application is a continuation-in-part application of U.S. patent application Ser. No. 14/931,868 filed Nov. 4, 2015 entitled SYSTEM AND METHOD FOR ENABLING A USER TO OVERCOME WEAK BEHAVIORAL TRAITS, which is hereby incorporated herein by reference. Benefits of priorities to all related applications are claimed.

### BACKGROUND

Unless otherwise indicated herein, the materials described in this section are not prior art to the claims in this application and are not admitted to be prior art by inclusion in this section.

### FIELD

The subject matter in general relates to behavioral traits in humans, and more particularly but not exclusively, the subject matter is directed to a technical solution to overcome weak behavioral traits and more particularly to overcome impatience, laziness and low trust issues, which are weak behavioral traits.

An individual's behavior towards others, attitudes and characteristics, defines his personality. Each individual's personality is a combination of both positive and negative traits. A person may be driven by his positive traits at times and by negative traits at other times. As a result, to classify a person into a single personality type is difficult, as there are several different behavioral traits a person can have. Behavioral traits may be influenced by genes and/or by the environment where he grew up or may have spent most of his time during the stage of brain development.

Understanding what makes people who they are has been a challenge in the world of psychology. One of the approaches used for determining the personality of a person is by way of taking a psychology based personality test. In such a test, the person answers a set of questions, and based on the answers gets a report detailing the type of personality that person may have. On the other hand, behavior of a person may be observed to determine weak personality traits in him.

Negative or weak traits in a person can lead to difficulty in achieving their life goals. Conventionally, people try to overcome their weaknesses when one understands one's weaknesses or weak traits. An individual may approach a counselor or a psychologist with a view that, the counselor or the psychologist may be able to help him address his negative or weak trait. The person may have to undergo several sessions with the counselor. Such sessions may deal with the negative trait via a broad based general (not focused at the root of the weak trait) approach, which may be effective in the short run. For example, if a person is trying to deal with stress, the person may be advised to engage in regular exercise, outdoor games, engage socially and so on, which may prove effective to an extent for the time being.

Currently, there are multiple games and applications that may work in the same way as a counseling process. Even these games deal with the negative trait via a general approach. As an example if a person is not capable of reading at good speed, the person is subjected to games related to reading to improve his speed of reading. Such approach may be effective in the short run and does not address negative traits in a wholesome manner.

In light of the foregoing discussion there is a need for an improved technique to overcome weak personality traits based on the goals of the person.

### SUMMARY

An embodiment provides a system for enabling a user to overcome impatience, laziness and low trust issues. The system includes an activity module. The activity module is configured to receive input indicating the desire to overcome at least one of impatience, laziness and low trust issues. Upon indication of impatience, the system enables the user to engage in at least a first activity in a virtual environment. The first activity is directed to rewire a first defective wiring of the brain. The first defective wiring results in an individual being biased to notice delays in a task rather than the successful completion of a task. The activity module is further configured to enable the user to engage in at least a second activity in the virtual environment. The second activity is directed to rewire a second defective wiring of the brain. The second defective wiring results in an individual's inability to weigh between delays in a task and the benefits of successful completion of a task. Symptom of the first and the second defective brain wirings is impatience. Upon indication of laziness, the system enables the user to engage in at least a first activity in a virtual environment. The first activity is directed to rewire a first defective wiring of the brain. The first defective wiring results in an individual being biased to think more on the effort required for a task rather than the rewards. The activity module is further configured to enable the user to engage in at least a second activity in the virtual environment. The second activity is directed to rewire a second defective wiring of the brain. The second defective wiring results in an individual's inability to weigh between the efforts required and rewards of a task. Symptom of the first and the second defective brain wirings is laziness. Upon indication of low trust issues, the system enables the user to engage in at least a first activity in a virtual environment. The first activity is directed to rewire a first defective wiring of the brain. The first defective wiring results in an individual being biased to give priority to information that conflict with the expressed thoughts/words/actions of another individual. The activity module is further configured to enable the user to engage in at least a second activity in the virtual environment. The second activity is directed to rewire a second defective wiring of the brain. The second defective wiring results in an individual's inability to weigh between the information that conflicts or agree with the expressed thoughts/words/actions of another individual. Symptom of the first and the second defective brain wirings is low trust issues. Additionally, the activity module is configured to provide automated instructions to the user to engage in at least one activity, wherein the one activity is performed in a real world environment. The activity is directed to rewire the first defective wirings of the brain corresponding to each of impatience, laziness and low trust issues. Furthermore, the activity module is configured to provide automated instructions to the user to engage in yet another activity. The yet another activity is performed in the real world environment. The yet another activity is directed to rewire the second defective wirings of the brain corresponding to each of impatience, laziness and low trust issues.

### BRIEF DESCRIPTION OF THE DRAWINGS

Embodiments are illustrated by way of example and not limitation in the Figures of the accompanying drawings, in which like references indicate similar elements and in which:

FIG. 1 is an exemplary architecture of an exemplary system 100 to overcome weak behavioral traits;

FIG. 2 is a block diagram of an exemplary activity module 200 to overcome weak behavioral traits;

FIGS. 2A-2C are block diagrams of an exemplary behavioral traits database 202, which includes information corresponding to weak behavioral traits, of the activity module 200;

FIG. 3A is a block diagram of an exemplary collection of games 204 present in the activity module 200 to overcome impatience;

FIG. 3B is a block diagram of an exemplary collection of games 204 present in the activity module 200 to overcome laziness;

FIG. 3C is a block diagram of an exemplary collection of games 204 present in the activity module 200 to overcome low trust issues;

FIG. 4A is a block diagram of an exemplary actions database 206 of the activity module 200 to overcome impatience;

FIG. 4B is a block diagram of an exemplary actions database 206 of the activity module 200 to overcome laziness;

FIG. 4C is a block diagram of an exemplary actions database 206 of the activity module 200 to overcome low trust issues;

FIG. 5 illustrates a flowchart of an exemplary method for overcoming impatience;

FIG. 6 illustrates a flowchart of an exemplary method for overcoming laziness; and

FIG. 7 illustrates a flowchart of an exemplary method for overcoming low trust issues.

### DETAILED DESCRIPTION

I. OVERVIEW
II. PRINCIPLE
III. SYSTEM ARCHITECTURE
IV. MODULES OF SYSTEM TO OVERCOME IMPATIENCE, LAZINESS AND LOW TRUST ISSUES
V. METHOD FOR OVERCOMING IMPATIENCE, LAZINESS AND LOW TRUST ISSUES

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a technical solution to overcome impatience, laziness and low trust issues, which are weak behavioral traits. The solution is based on a principle that genetic and environmental factors (may be referred to as “cause”) cause defects in human brain wiring (may be referred to as “defect”), and such defects in human brain wiring express themselves in the form of impatience, laziness and low trust issues (may be referred to as “symptoms”); hence, to overcome these, the defective brain wirings have to be rewired, thereby providing a wholesome and long term solution to weak behavioral traits.

The system may include an activity module. The activity module may be configured to enable the user to engage in activities in a virtual environment. The activities in the virtual environment facilitate rewiring of defective brain wirings. The activity module may be further configured to provide automated instructions to gradually expose the user to situations in a real environment. The situations may be generally uncomfortable to the user as a result of the defective brain wirings. Exposure to such situation facilitates rewiring of the defective brain wirings.

In an embodiment, a system is provided to overcome impatience, laziness and low trust issues. Activities in the virtual environment facilitate rewiring of defective brain wirings, wherein the symptom of the defective brain wirings is at least one of impatience, laziness and low trust issues. Exposure to real world situation facilitates rewiring of the defective brain wirings.

The activity in the virtual environment may be a brain game. There may be a plurality of levels in the brain game. Each level in the game may have to be successfully completed by the user to unlock a subsequent higher level in the game.

The real world activity may take place in the real world environment, subsequent to the brain games. There may be a plurality of levels in the real world activity.

### II. Principle

Behavioral traits are in fact symptoms or consequences of the way an individual's brain is wired. The way an individual's brain is wired is based on the joint influence of genetic and environmental factors. With regards to each kind of brain wiring, genetic and environmental factors may work together in different proportions.

Embodiments provide a solution to rewire the defective brain wiring (addressing the defect) rather than just addressing the behavioral trait (symptom) without addressing the core defect.

It is important to identify the brain wiring that results in development of a trait. A wholesome approach to overcome or eradicate a negative or a weak behavioral trait in a person would be to implement ways to rectify defect in the brain wiring.

Brain wirings may be referred to as connections of neural pathways in the brain. These connections of the brain form beliefs, thought patterns and response patterns to external stimulation. Rewiring may be referred to as a process of creating new brain wiring and stimulating a person's existing brain wirings so that his beliefs, thought patterns and responses to external stimulation change for the better.

Impatience is the inability to accept delays and the urge toward restlessness and anxiety when confronted with an unexpected situation.

Impatience is in fact a symptom or consequence of the way an individual's brain is wired. The way an individual's brain is wired is based on the joint influence of genetic and environmental factors. With regards to each kind of brain wiring, genetic and environmental factors may work together in different proportions.

With regards to impatience, the brain of the person with impatience is wired such that the person tends to notice delays in a task rather than the successful completion of a task. Additionally, the brain of the person with impatience is wired such that the individual is unable to weigh between the delays in a task and the benefits of successful completion of a task, which is another defective brain wiring. Such defective brain wirings may have been caused by one or more of genetic predisposition such as, predominantly low serotonin in the brain or parenting. Further impatience may also be a result of immediate gratification while growing up as needs have been met without having to necessarily wait for something and/or no gratification.

Different brain regions and neural network of the individual are responsible for impatience. Neural network of a person with impatience involves dorsolateral prefrontal cortex, medial prefrontal cortex, orbito frontal cortex, nucleus accumbens, amygdala, and dorsal raphe nucleus. It has been proved by research that people with less patience have less activity in dlPFC, mPFC, OFC and activity in amygdala is very high. Reduced level of serotonin in the CNS promotes restless behavior, including restless action and restless choice. Serotonin efflux in the DRN increases when an individual performs a task that requires waiting for a delayed response. DRN is the primary source of serotonin synthesis. Many DRN neurons are active when there is a delayed reward because it releases serotonin to keep the restless action under control. Similar to behavioral inhibition the term action inhibition is used to explain the inhibitory control of animal behavior. Action inhibition happens when the motor function stops due to the availability of serotonin in the brain.

The core regions of the NAcc contribute both to DRN inhibition and to premature response. This means that if there is less activation in both these regions the brain is unable to hold on one decision and takes the other route to get to a more immediate reward and become restless. Lesions in the PFC, mainly the dorsal part of the mPFC and the OFC induces premature response.

In the OFC and mPFC a sustained increase in the activity has been observed during waiting for delayed reward. OFC and mPFC remains very active when there is a delayed reward. DRN serotonin neurons projects to the NAcc, mPFC and OFC. The OFC transmits the confidence to the existing reward and also involved in reward prediction. It has been observed that the activity or lesions in OFC results in difficulty in evaluating appropriately immediate rewards against future losses owing to an inability to be motivated by mental representation of future states. Lesion in the OFC leads to estimation that significantly more time had passed during the work than normal one. OFC patients have a faster subjective sense of time.

It has been observed that dLPFC is also involved in cognitive control over an action. It does facilitation of abstract reasoning. Variability of value prediction is associated with dLPFC. Heightened prefrontal activity inhibits the amygdala, a major emotions center. Reduced amygdala activity causes a patient person to be systematically less deterred by fear, anger and annoyance in the face of provocation.

Laziness is disinclination to activity or exertion despite having the ability to act or exert oneself.

With regards to laziness, the brain of a lazy person is wired such that the person tends to think more on the effort required for a task rather than the rewards. Additionally, the brain of the person with laziness is wired such that the individual is unable to weigh between the efforts required and rewards of a task, which is another defective brain wiring. Such defective brain wirings may have been caused by one or more of genetic predisposition. Further impatience may also be a result of parental upbringing that might cause the child to diminish the value of rewards, increased tolerance of the reward system or over exposure to stimuli that gives pleasure leading to increase tolerance towards dopamine which is the crucial neurotransmitter involved in the reward system of the brain and fear of failure when an individual is continuously criticized it may lead to their failure to see the rewards for their work.

Different brain regions and neural network of the individual are responsible for laziness. A healthy functioning dorsal medial habenula is thought to influence mood, motivation (specifically to exercise), as well as improves an animal's ability to survive in a world filled with danger, risks, and rewards. Dysfunction of the habenula is associated with an increased likelihood of developing mood deregulation. Research findings support the idea that the habenula can influence voluntary motivation to exercise or to do work.

### The Key Influences of Habenula:

Habenula-inhibition is linked to lack of motivation.
Habenula stimulation is associated with motivation, reward, and pleasure.
Dorsal medial habenula controls desire to exercise (for mice).
Habenula-inhibition is associated with less reward and less motivation.
Habenula stimulation is associated with exercise which is inversely proportional to laziness

It has also been found through research that lazy people always find a loophole or shortcuts to complete the task and get the reward. Furthermore, the researcher have identified out that people who identified as apathetic had less efficient connections between the anterior cingulate cortex, a part of the brain involved in making decisions and anticipating rewards, and the supplementary motor area, a part of the brain that helps control movement.

The brain's pre frontal cortex is the place where motivation has been believed to take place, along with a handful of other high-level processes, like decision-making, social behavior, and abstract thinking. A new study not only confirms this belief, but actually illustrates the networks of brain cells that are involved, from the “highest” point—the prefrontal cortex—down to the cells of the motor cortex which help carry out the physical action to go along with motivation. The neural network runs from pre frontal cortex to motar area (raphe nucleus) in order to exhibit an action.

The weaker connection between pre frontal cortex, anterior cingulate cortex (ACC), habenula, and the motar area will make a person lazy. Stronger connection between ACC and pre motar cortex will make a person to find a loop hole or short cuts to complete the task.

Low trust is a state comprising of resistance to accept vulnerability based on the negative expectations of the actions of the other.

With regards to low trust issues, the brain of a person with low trust issues is wired such that the person tends to give priority to information that conflict with the expressed thoughts/words/actions of another individual. Additionally, the brain of the person with low trust issues is wired such that the individual is unable to weigh between the information that conflicts or agree with the expressed thoughts/words/actions of another individual, which is another defective brain wiring. Such defective brain wirings may have been caused by one or more of genetic predisposition. Further low trust issues may also be a result of negative working models of others and insecure attachment patterns, that is, not being able to establish emotional ties with people due to rejection, abuse or neglect by significant people early in life.

Different brain regions and neural network of the individual are responsible for low trust issues. The parts of the brain which get activated when a person has trust issues are Orbito-Frontal Cortex (OFC), insular cortex (IC) and Amygdala. When a person is in the state of low trust, the OFC is highly activated and increases uncertainty in a person. This leads to the activation of IC (associated with fear of loss and insecurity) and Amygdala (which plays an important role in carrying out intense negative emotions such as worry, suspicion etc). When a person has high levels of trust, OFC is down-regulated, which further activates Anterior Para-Cingulate Cortex (APCC), Septal Area (SA), Ventral Tagemental Area (VTA) and Caudate Nucleus (CN). VTA and CN are associated with hope and positive rewards, APPCC and SA are responsible for cooperative intentions. Thus when OFC is high, a low level of trust is observed and when its low, high levels of trust is observed.

### III. System Architecture

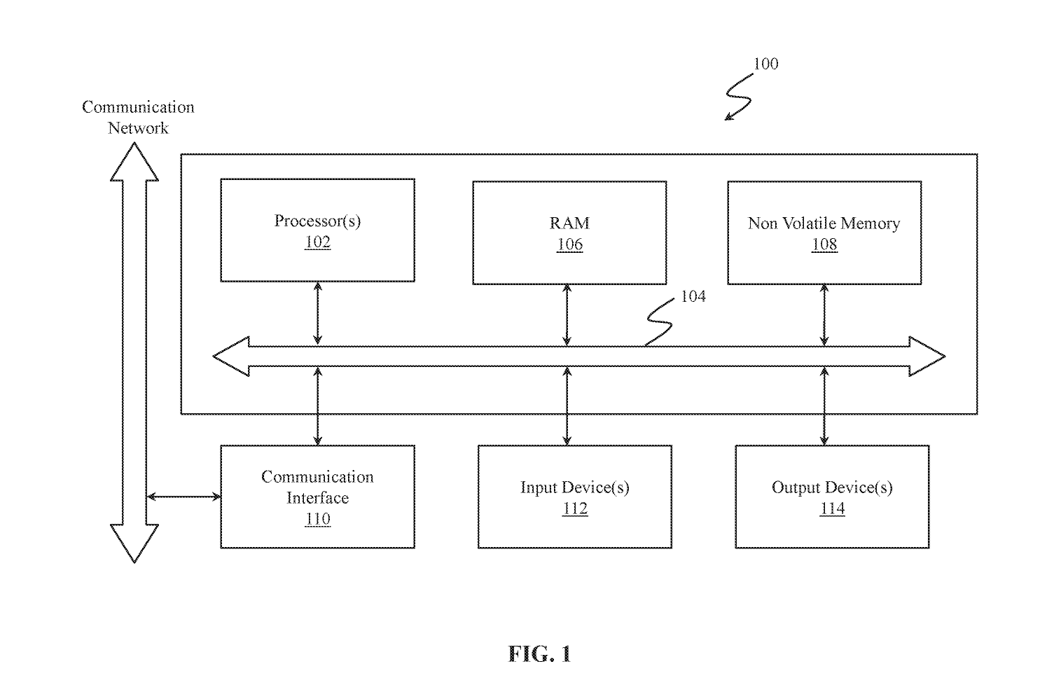

Referring to the figures, more particularly to FIG. 1, an exemplary architecture of an exemplary system 100 to overcome impatience is provided. The system 100 include one or more processors 102, a bus system 104, a random access memory 106, a disk drive or non-volatile memory 108, a communication interface 110, input device(s) 112 and output device(s) 114. Further, functionality of the system 100 may be distributed across multiple devices that may be located remotely from each other.

The processor 102 may be any hardware which returns output by accepting signals, such as electrical signals as input. In one embodiment, processors 102 may include one or more processing units (CPUs). The processor(s) 102 may communicate with a number of peripheral devices via the bus system 104. The processor(s) 102 may be implemented as appropriate in hardware, computer-executable instructions, firmware, or combinations thereof. Computer-executable instruction or firmware implementations of the processor(s) 102 may include computer-executable or machine-executable instructions written in any suitable programming language to perform the various functions described.

Communications interface 110 may provide an interface to other communication networks and devices. The input devices 112 may include all possible types of devices and mechanisms for inputting information to system 100. The output devices 114 may include all possible types of devices and mechanisms for outputting information from the system 100. The system 100 may include memory that may store data and program instructions that are loadable and executable on the processor(s) 102, as well as data generated during the execution of these programs. The memory may be volatile, such as random access memory 106 and/or a disk drive or non-volatile memory 108.

### IV. Modules of System to Overcome Impatience, Laziness and Low Trust Issues

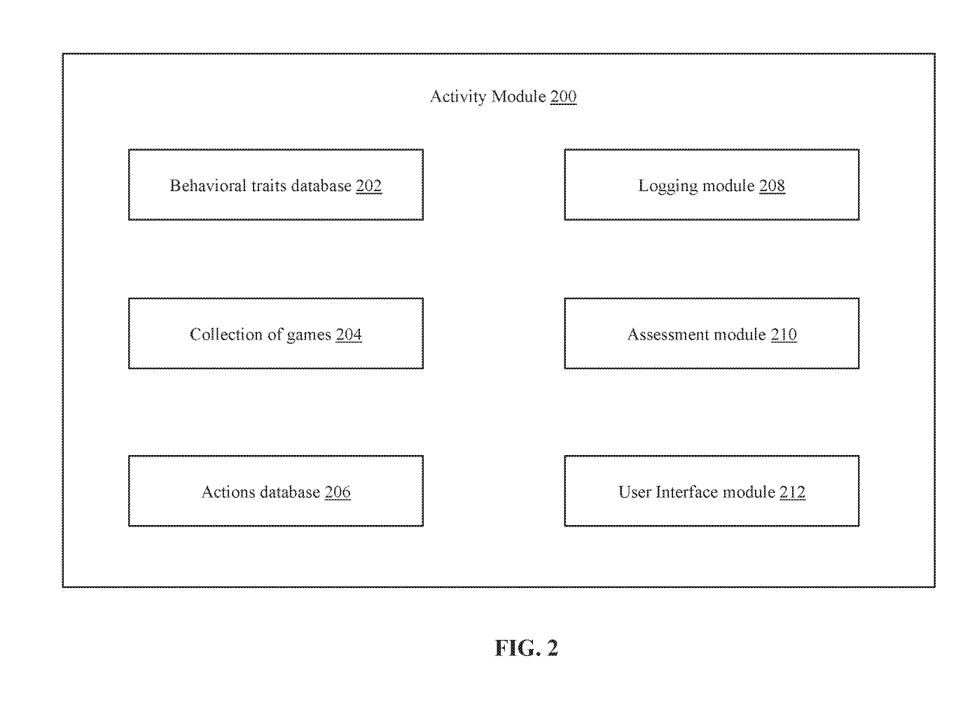

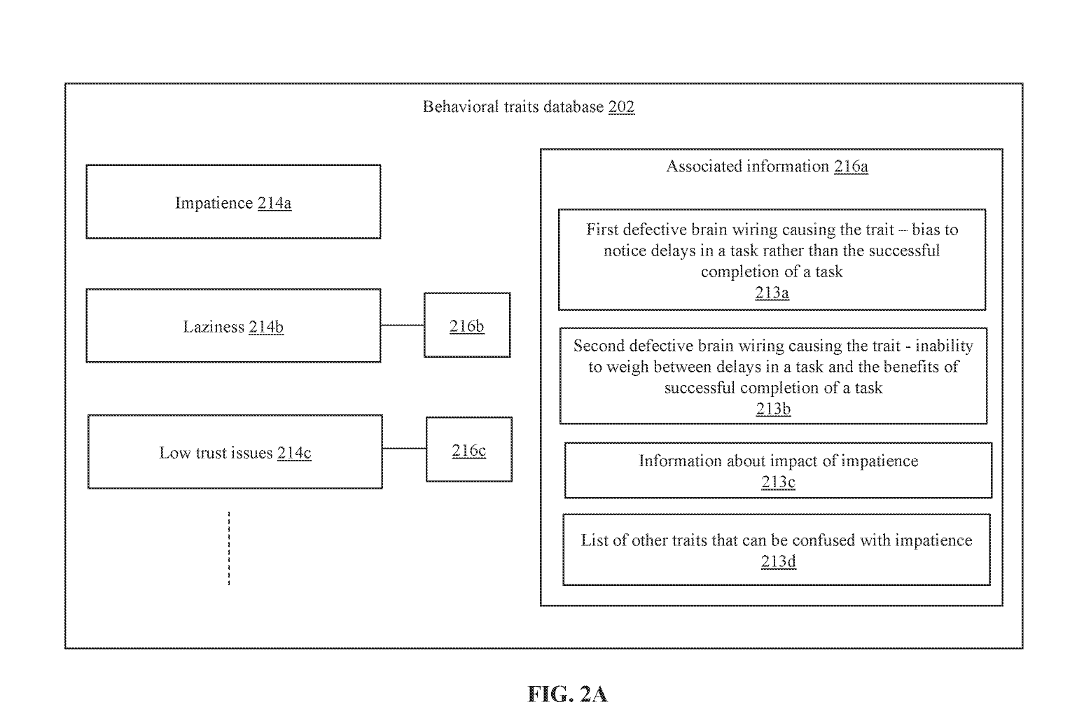

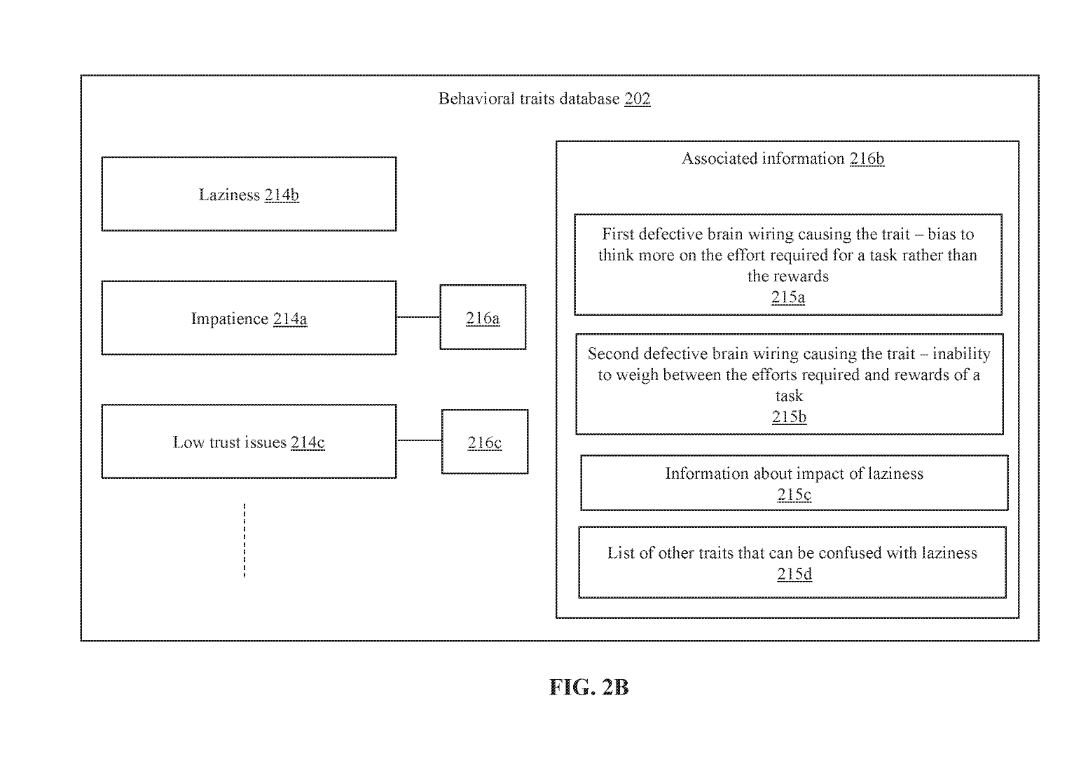

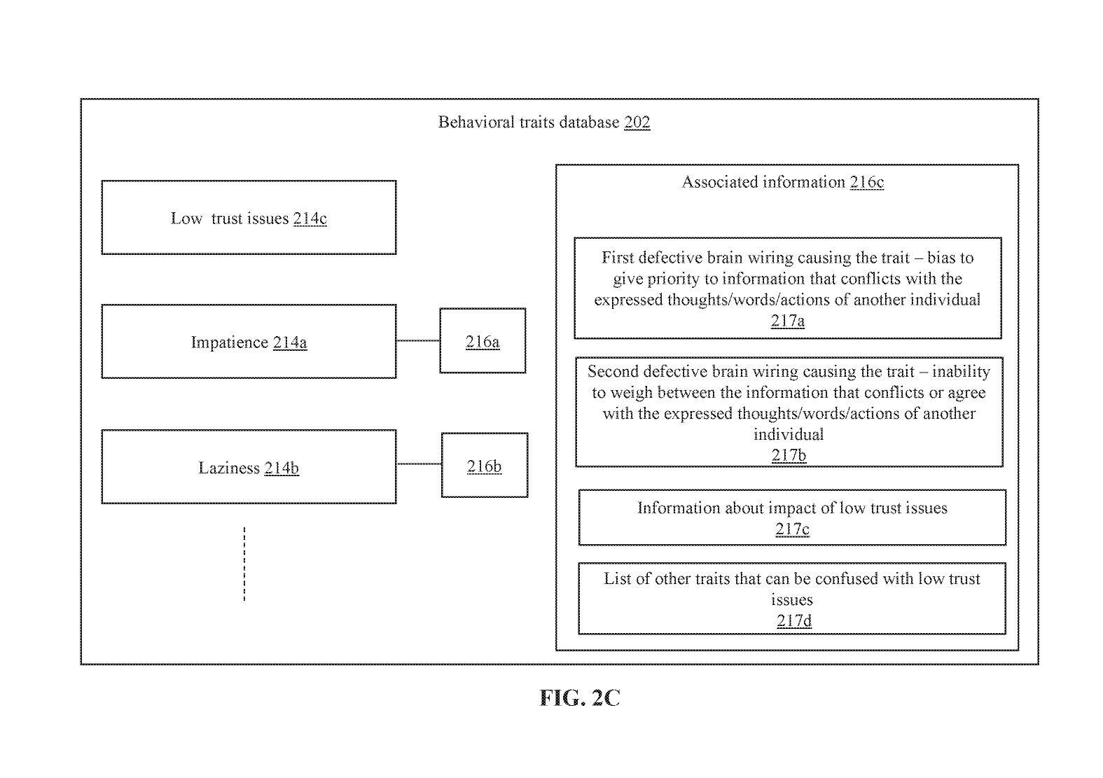

Referring to the figures, and more particularly to FIG. 2, the system 100 includes various modules for enabling users to overcome impatience, laziness and low trust issues. The system 100 includes an activity module 200. The activity module 200 may be a gaming module or an application module. The activity module 200 may be hosted by a communication device that enables a user to play games. Examples of such communication devices may include smart phone, tablet, notebook, laptop and desktop computer, among other devices.

The activity module 200 may include a behavioral traits database 202, a collection of games 204, an actions database 206, a logging module 208, an assessment module 210 and a user interface module 212.

### Behavioral Traits Database 202

Referring to FIGS. 2A-2C, in an embodiment, the behavioral traits database 202 may include a list of behavioral traits 214. Examples of behavioral traits 214 include, but not limited to, impatience 214a, laziness 214b and low trust issues 214c, among others. The traits database 202 may further include, with respect to impatience 214a, information associated 216a, with respect to laziness 214b, information associated 216b and with respect to low trust issues 214c, information associated 216c.

With regards to impatience 214a, the associated information 216a may include information corresponding to the defective brain wirings (defects) 213a, 213b causing impatience (symptom of the defect), information about impact 213c of impatience 214a on a person, and a list 213d comprising one or more traits that may be confused with impatience 214a, among other information. Some or all of the associated information 216a may be displayed to the user of the activity module 200.

A first defective brain wiring 213a causing impatience 214a is the brain wiring causing a bias to notice delays in a task rather than the successful completion of a task. A second defective brain wiring 213b causing impatience 214a is the brain wiring causing inability to weigh between the delays in a task and the benefits of successful completion of a task.

In an embodiment, the information corresponding to the first and second defective brain wirings 213a, 213b causing impatience 214a enable the activity module 200 to select games, activities or actions to overcome impatience 214a.

In an embodiment, displaying the information corresponding to the defective brain wiring (defect) 213a, 213b causing impatience 214a helps the user in understanding the defects responsible for impatience 214a, thereby motivating the user to follow the instructions provided by the activity module 200.

Information about impact 213c of impatience 214a can include one or more of jumping into conclusions or actions without analyzing the situations appropriately, amending planned goals, irritation, anger, impulsiveness, restlessness, anxiety and tendency to want things immediately and failure of satisfaction leading to disinterest in the task, among others.

List 213d of other traits that can be confused with impatience 214a include anxiety, social anxiety, perfectionism and depression, among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome impatience 214a.

With regards to laziness 214b, the associated information 216b may include information corresponding to the defective brain wirings (defects) 215a, 215b causing laziness (symptom of the defect), information about impact 215c of laziness 214a on a person, and a list 215d comprising one or more traits that may be confused with laziness 214b, among other information. Some or all of the associated information 216b may be displayed to the user of the activity module 200.

A first defective brain wiring 215a causing laziness 214b is the brain wiring causing a bias to think more on the effort required for a task rather than the rewards. A second defective brain wiring 215b causing laziness 214b is the brain wiring causing inability to weigh between the efforts required and rewards of a task.

In an embodiment, the information corresponding to the first and second defective brain wirings 215a, 215b causing laziness 214b enable the activity module 200 to select games, activities or actions to overcome laziness 214b.

In an embodiment, displaying the information corresponding to the defective brain wiring (defect) 215a, 215b causing laziness 214b helps the user in understanding the defects responsible for laziness 214b, thereby motivating the user to follow the instructions provided by the activity module 200.

Information about impact 215c of laziness 214b can include one or more of lack of motivation, inability to control impulses, neglect of diet, exercise, medical treatment, false belief of no power to change, procrastination, lack of goal setting, inability to prioritize, delegation and shortcuts to completing any tasks among others.

List 215d of other traits that can be confused with laziness 214b include anxiety, social anxiety, self-esteem, perfectionism and depression, among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome laziness 214b.

With regards to low trust issues 214c, the associated information 216c may include information corresponding to the defective brain wirings (defects) 217a, 217b causing laziness (symptom of the defect), information about impact 217c of low trust issues 214c on a person, and a list 217d comprising one or more traits that may be confused with low trust issues 214c, among other information. Some or all of the associated information 216c may be displayed to the user of the activity module 200.

A first defective brain wiring 217a causing low trust issues 214c is the brain wiring causing a bias to give priority to information that conflict with the expressed thoughts/words/actions of another individual. A second defective brain wiring 217b causing low trust issues 214c is the brain wiring causing inability to weigh between the information that conflicts or agree with the expressed thoughts/words/actions of another individual.

In an embodiment, the information corresponding to the first and second defective brain wirings 217a, 217b causing low trust issues 214c enable the activity module 200 to select games, activities or actions to overcome low trust issues 214c.

In an embodiment, displaying the information corresponding to the defective brain wiring (defect) 217a, 217b causing low trust issues 214c helps the user to understand the defects responsible for low trust issues 214c, thereby motivating the user to follow the instructions provided by the activity module 200.

Information about impact 217c of low trust issues 214c can include one or more of decreased willingness to share private/important information with other people, persistent suspicion about other person's motives and intentions, reluctance to accept vulnerability and avoid interdependence, guarded and limited interaction with people, experiencing feeling of apprehension or uneasiness while dealing with other people and high vigilance of other people, among others.

List 217d of other traits that can be confused with low trust issues 214c include low empathy and introversion, among others.

In an embodiment, the activity module 200 displays the information corresponding to the brain rewiring that the activity module 200 is attempting to achieve to overcome the weak behavioral trait 214, thereby enabling the user to understand the actual goal he will be instructed to work towards, which in turn can overcome low trust issues 214c.

### Collection of Games 204

The activity module 200 includes a collection of digital games 204, which are played in a virtual world. Each of the games 204 is used by the activity module 200 based on the brain rewiring, which the game 204 is capable of achieving.

In an embodiment, with regards to impatience 214a, each game 204a-204b (may be referred to as game 204 or games 204) may include associated information 218a. As an example, a game may be capable of achieving more than one type of brain rewiring. Alternatively, one single type of rewiring may be achieved through more than one game. Each game 204 includes data indicating the brain rewiring(s) 219a, 225a it is capable of achieving, so that the activity module 200 can opt to present a choice of one or more games, which has the capability to achieve the brain rewiring, which the activity module 200 is attempting to achieve.

The associated information 218a may further include instructions 221a to be followed by the user to play the game 204. The associated information 218a may additionally include one or more rules 223a. Examples of rules include rules for playing each game, rules to proceed to a higher level, scoring method in each level and time assigned to each level to reach the end of the level, among others.

In an embodiment, a higher level of the digital game 204 is unlocked based on predefined criteria.

In an embodiment, the higher level is unlocked upon repeatedly playing a previous level in the digital game 204 for a predefined number of times or duration of time.

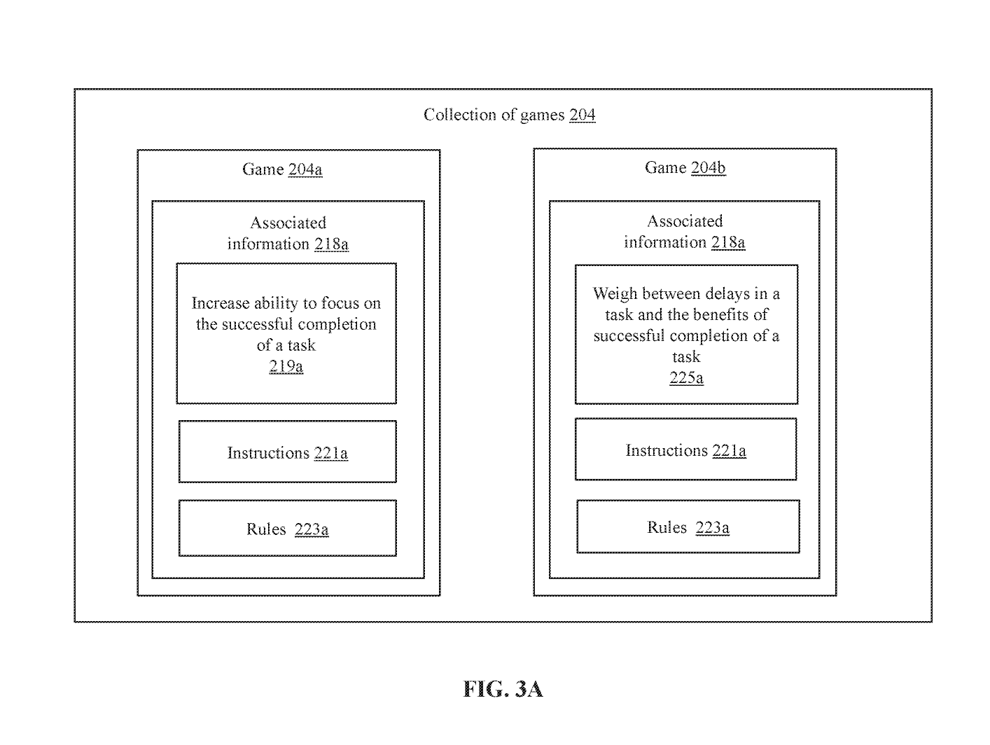

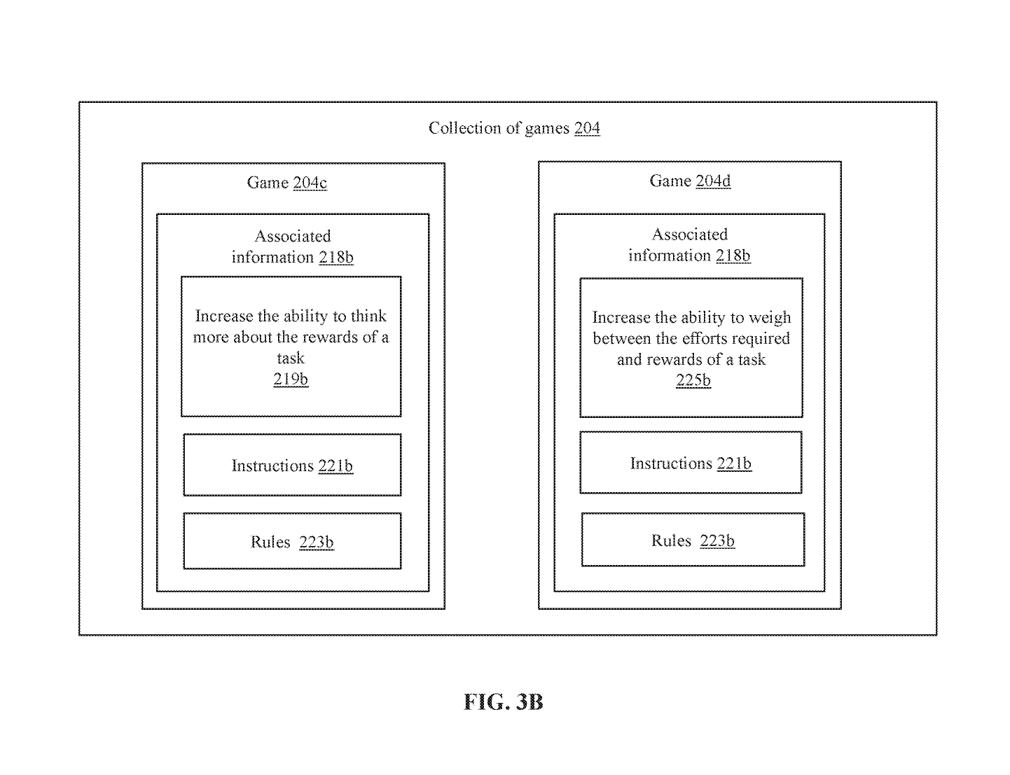

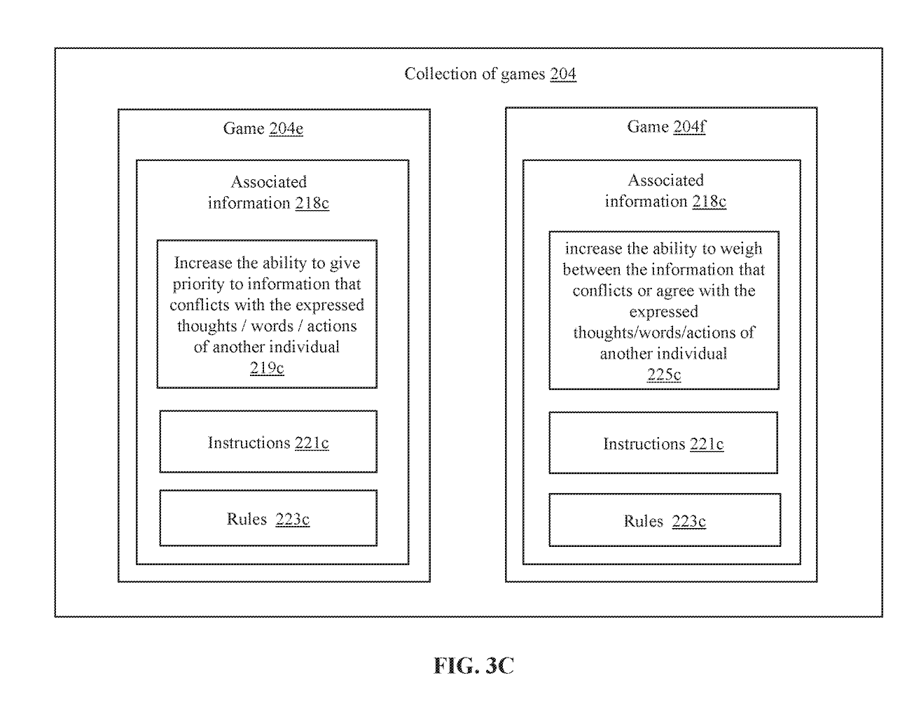

In the example presented in FIG. 3A, two different games 204a-204b are included in the collection of games 204. The games 204a and 204b can be used by the activity module 200 to correct the defective brain wirings 213a and 213b by rewiring the brain to increase the ability focus on the successful completion of a task 219a and increase the ability to weigh between delays in a task and the benefits of successful completion of a task 225a.

Game 204a is directed at rewiring 219a the brain to increase the ability to focus on the successful completion of a task. The game 204b is directed at rewiring 225a the brain to increase the ability to weigh between delays in a task and the benefits of successful completion of a task.

Game 204a is designed to rewire the brain to increase the ability to focus on the successful completion of a task. Instruction 221a may include recommendation to play the game 204a for a minimum of fifteen minutes every day, as an example. The rules 223a may allow proceeding to a next level in the game 204a once a desired level of performance is achieved.

Game 204a may be selections game, wherein a situation will be shown and one statement from each of the two categories shown below will be chosen randomly and displayed. The user has to select one statement from the two giving preference for the statement that helps them focus on the successful completion of a task. One example is provided below.

### Situation:

You are on your way for a meeting but there is heavy traffic.

### Delays in a Task

I see other people cutting the line.
I am stuck behind a slow moving truck.
There is no traffic police to manage the traffic.
The traffic signal is not functioning.
There is an accident ahead.
I have a meeting scheduled in an hour.
People are not maintaining lane discipline.
Everyone has slowed down as the road is damaged with a lot of potholes.
People do not seem to be co-operative so as to move faster.
The road is very narrow and is slowing the traffic down.

### Successful Completion of a Task

I can start the meeting over the phone.
My colleagues are qualified enough to handle the meeting.
I have the authority to postpone the meeting.
My colleagues can keep the meeting going until I arrive.
I am well-prepared so that the meeting can start as soon as I arrive.
I have all the necessary documents required for the meeting.
The traffic usually clears up.
I have always been a punctual person.
My boss is very considerate of me.
The distance to be covered is minimal.

Game 204b may be designed to enhance one's ability to weigh between the delays in a task and the benefits of successful completion of a task 225a. Instruction 221a may include recommendation to play the game 204b for at least a predefined duration for a predefined number of days. Rules 223a may allow proceeding to a next level in the game 204b once a desired level of performance is achieved.

Game 204b, may be a facts game, wherein a situation will be shown and the facts for the situation will be picked randomly from two categories. The user has to answer a question on the situation by selecting Yes or No. One example is presented below:

### Situation/Event: Your Friend is Late by Fifteen Minutes

### Delays in a Task

You have to go for an appointment after meeting my friend.
Your friend is stuck in traffic.
Your friend always comes late.
You are usually a punctual person.
Your friend is not receiving your call so you are unsure as to where he/she is.
You have not planned appropriately for this meeting.
Your friend has not confirmed if he/she is meeting you.
You had to cancel an important event to meet your friend.
You have to travel quite a distance after you meet your friend.
You might face a lot of traffic after the meeting.

### Benifis of Successful Completion of a Task

Time spent with that friend is always good.
You had a busy week previously and need some recreation.
Your friend is a very interesting person.
Your friend was going through a tough time and needs your support.
Your friend has always been there for you.
You haven't met your friend for a long time.
You had to share something important with your friend.
You share friendship with him/her for a long time now.
Your friend had been patient when you were late sometimes.
Your friend stays far away.
   Q. So should you be patient and wait for your friend?

### Answer:

### Yes

### No

The answer should be “Yes”

In an embodiment, with regards to laziness 214b, each game 204c-204d (may be referred to as game 204 or games 204) may include associated information 218b. As an example, a game may be capable of achieving more than one type of brain rewiring. Alternatively, one single type of rewiring may be achieved through more than one game. Each game 204 includes data indicating the brain rewiring(s) 219b, 225b it is capable of achieving, so that the activity module 200 can opt to present a choice of one or more games, which has the capability to achieve the brain rewiring, which the activity module 200 is attempting to achieve.

The associated information 218b may further include instructions 221b to be followed by the user to play the game 204. The associated information 218b may additionally include one or more rules 223b. Examples of rules include rules for playing each game, rules to proceed to a higher level, scoring method in each level and time assigned to each level to reach the end of the level, among others.

In the example presented in FIG. 3B, with regards to laziness 214b, two different games 204c-204d are included in the collection of games 204. The games 204c and 204d can be used by the activity module 200 to correct the defective brain wirings 215a and 215b by rewiring the brain to increase the ability to think more about the rewards of a task 219b and increase the ability to weigh between the efforts required and rewards of a task 225b.

Game 204c is directed at rewiring 219b the brain to increase the ability to think more about the rewards of a task. The game 204b is directed at rewiring 225b the brain to increase the ability to weigh between the efforts required and rewards of a task.

Game 204c is designed to rewire the brain increase the ability to think more about the rewards of a task 219b. Instruction 221b may include recommendation to play the games 204c for a minimum of fifteen minutes every day, as an example. The rules 223b may allow proceeding to a next level in the game 204c once a desired level of performance is achieved.

Game 204c may be selections game, wherein a situation will be shown and one statement from each of the two categories shown below will be chosen randomly and displayed. The user has to select one statement from the two giving preference for the statement that helps them focus on the successful completion of a task. One example is provided below:

Your doctor suggested that you cook your meals rather than eating out.

### Efforts Required:

I need to dedicate more time to cooking
I have to shop for all the ingredients
I have to learn new recipes.
I need to wash dishes.
I have to be patient while cooking
I need to clean the kitchen regularly
I might need to cook the food again if it tastes bad.
I can sleep more if I don't cook.
I need to constantly pay attention otherwise the dish can get spoilt.

### Rewards of the Task:

1. I will save up money.

2. I will learn cooking which can be useful.

3. I do not have to wait in the restaurants.

4. I do not have to travel.

5. My relationship with my doctor will improve as I followed his suggestions.

6. I will be able to eat freshly cooked food.

7. I get to eat whenever I desire to rather than waiting at the food courts.

8. I will become independent.

9. My health will get better

10. I will be less susceptible to food poisoning

Game 204d is designed to rewire the brain increase the ability to weigh between the efforts required and rewards of a task 225b. Instruction 221b may include recommendation to play the games 204d for a minimum of fifteen minutes every day, as an example. The rules 223b may allow proceeding to a next level in the game 204d once a desired level of performance is achieved.

Game 204d may be facts game, wherein a situation will be shown and the facts for the situation will be picked randomly from the two categories. The user has to answer a question on the situation by selecting Yes or No. One example is provided below:

You have an important exam in a month that you need to prepare for.

### Efforts Required:

I might have to collect notes.
I might have to read many books.
I might have to brush up all my basic knowledge.
I will have to very attentive to grasp various concept.
I might have to understand the pattern of the questions being asked previously.
I have to vigorously search for research articles.
I might have to visit the library.
I might have to shorten my sleep time.
I have to reduce socializing.
I have to pay attention to different subjects equally.

### Rewards of the Task:

I will be able to get into a career that I have been passionate about.
My career will be set.
I will be qualified to start up something myself with that degree.
I will acquire in-depth knowledge about the subject.
It will be useful for me in the future.
I will be able to freshen my basic knowledge.
Studying for the exams will higher up the chances of being better for the exam.
The remuneration I receive later will satisfy my financial expectation.
My self confidence will increase because of the effort I will put in.
The knowledge I acquired can be taught to other individuals.
   Q. Will you be ready for the exam?/Do you feel this exam requires your attention?/Do you feel the required effort is worth?

### Answer: Yes or No

The correct answer should be “Yes”.

In an embodiment, with regards to low trust issues 214c, each game 204e-204f (may be referred to as game 204 or games 204) may include associated information 218c. As an example, a game may be capable of achieving more than one type of brain rewiring. Alternatively, one single type of rewiring may be achieved through more than one game. Each game 204 includes data indicating the brain rewiring(s) 219c, 225c it is capable of achieving, so that the activity module 200 can opt to present a choice of one or more games, which has the capability to achieve the brain rewiring, which the activity module 200 is attempting to achieve.

The associated information 218c may further include instructions 221c to be followed by the user to play the game 204. The associated information 218c may additionally include one or more rules 223c. Examples of rules include rules for playing each game, rules to proceed to a higher level, scoring method in each level and time assigned to each level to reach the end of the level, among others.

In the example presented in FIG. 3C, with regards to low trust issues 214c, two different games 204e-204f are included in the collection of games 204. The games 204e and 204f can be used by the activity module 200 to correct the defective brain wirings 217a and 217b by rewiring the brain to increase the ability to give priority to information that agrees with the expressed thoughts/words/actions of another individual 219c and increase the ability to weigh between the information that conflicts or agree with the expressed thoughts/words/actions of another individual 225c.

Game 204e is directed at rewiring 219c the brain to increase the ability to give priority to information that agrees with the expressed thoughts/words/actions of another individual. The game 204f is directed at rewiring 225b the brain to increase the ability to weigh between the information that conflicts or agree with the expressed thoughts/words/actions of another individual.

Game 204e is designed to rewire the brain to increase the ability to give priority to information that agrees with the expressed thoughts/words/actions of another individual. Instruction 221c may include recommendation to play the games 204e for a minimum of fifteen minutes every day, as an example. The rules 223c may allow proceeding to a next level in the game 204e once a desired level of performance is achieved.

Game 204e may be selections game, wherein a situation will be shown and one statement from each of the two categories shown below will be chosen randomly and displayed. The user has to select one statement from the two, giving preference for the statement that helps them give priority to information that agree with the expressed thoughts/words/actions of another individual. One example is provided below:

Your colleague offers to drop you home after work.
Information that Conflict with Others:
Your colleague might be pretending to be nice.
Your colleague's motives might be wrong.
You heard from your friends that he is accident prone.
The colleague might intrude into your personal space.
This colleague might start gossiping about you if you go with him.
Your colleague might hold this favour against you and ask for a favour later.
Your colleague might project it as if you asked for a favour in front of others.
Your colleague might be offering to drop to please you.
Your colleague might misbehave with you.
It looks like your friend has not maintained his car in a good condition and it may break down.

Game 204f is designed to rewire the brain to increase the ability to weigh between the information that conflicts or agree with the expressed thoughts/words/actions of another individual. Instruction 221c may include recommendation to play the games 204f for a minimum of fifteen minutes every day, as an example. The rules 223c may allow proceeding to a next level in the game 204f once a desired level of performance is achieved.

Game 204f may be facts game, wherein a situation will be shown and the facts for the situation will be picked randomly from the two categories. The user has to answer a question on the situation by selecting Yes or No. One example is provided below:

Your friend wants to borrow your laptop.
Information that Conflict with Others:
Your friend has lost your belongings in the past.
Your friend might make borrowing a habit.
Your laptop might crash when he uses it.
Your friend might install certain softwares which can slow your laptop.
Your friend is not organized in his work.
Your friend might hack your laptop for his benefits.
Your friend might start looking at your personal files.
Your laptop might come back with scratches.
Your friend might copy some of your assignments.
Your laptop might get infected with virus.
   Information that Agree with Others:
You have let him borrow your belongings before.
You know this friend for quite some time.
Your friend being a technical professional knows how to use a laptop.
Your friend has helped you when you were in need.
Your friend writes blogs on the maintenance of laptops.
Your friend has assured to return your laptop in few days in the same condition.
Your friend said he will buy you a new one, in case something goes wrong with your laptop.
Your friend had helped you to assemble your laptop.
Your friend assured to give you constant updates on your laptop.
Your friend will update your laptop to the recent version as a favor
   Q. Would you let your friend borrow your laptop?

### Answer: Yes or No

The appropriate answer should be “Yes”.

### Actions Database 206

The actions database 206 includes information corresponding to a plurality of real world activities or sets of real world activities. Real world activities may include activities that are performed in a real world environment, as opposed to the digital games played in the virtual world (ex: games included in the collection of games 204).

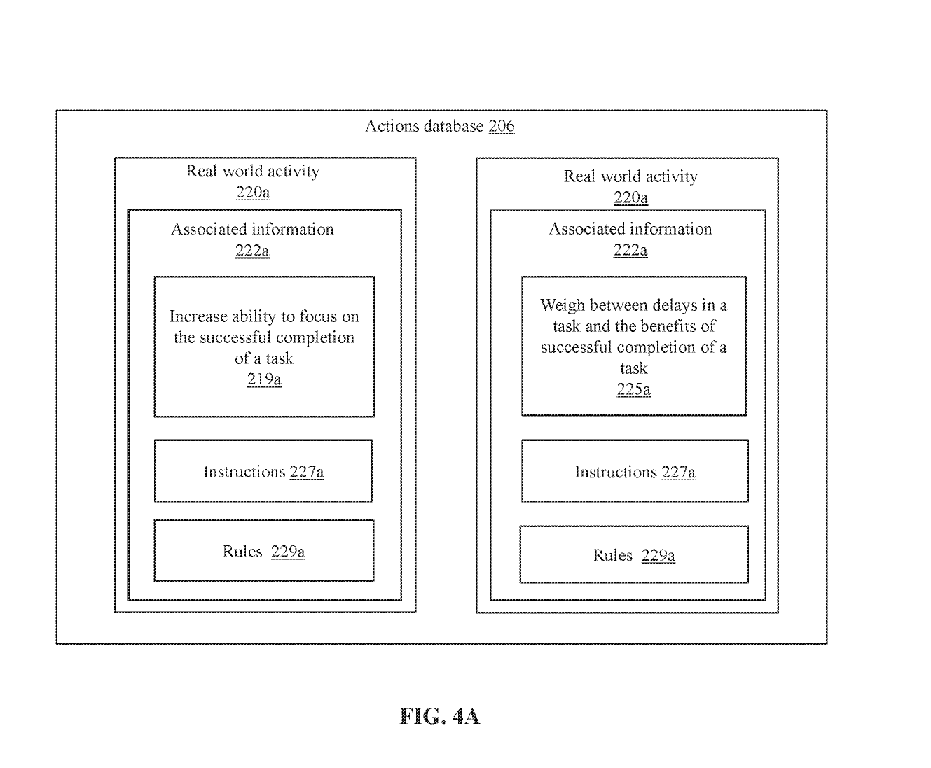

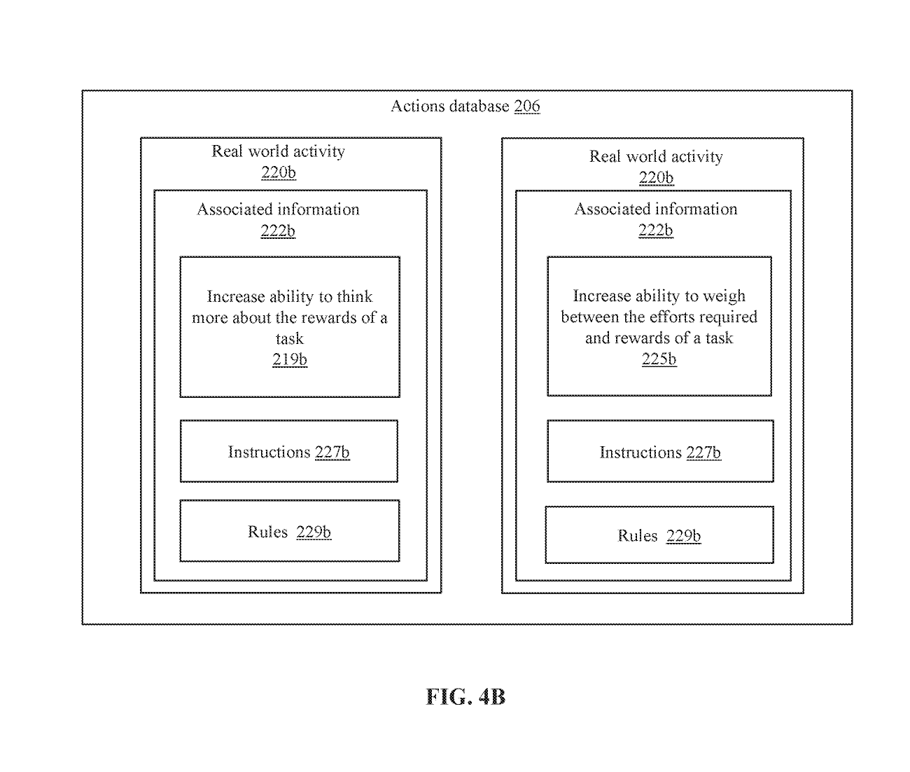

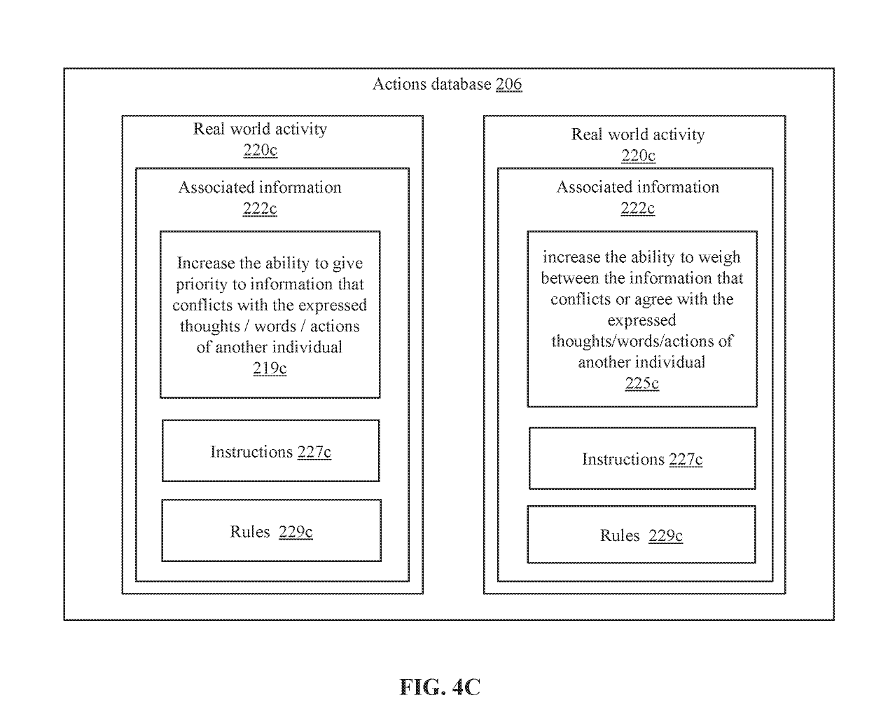

Referring to FIG. 4A, with regards to impatience 214a, the real world activities 220a or sets of real world activities 220 (may be referred by numeral 220a) is used by the activity module 200 based on the brain rewiring 219a, 225a, which the real world activity 220a is capable of achieving.

Each real world activity 220 may include associated information 222a. As an example, a real world activity may be capable of achieving more than one type of brain rewiring. Alternatively, one type of rewiring may be achieved through one or more real world activities. Each real world activity 220 includes data indicating the brain rewiring(s) 219a, 225a it is capable of achieving, so that the activity module 200 can opt to present a choice of one or more real world activities 220a, which has the capability to achieve the brain rewiring, which the activity module 200 is attempting to achieve.

The associated information 222a may further include instructions 227a to be followed by the user to perform the real world activity 220a or a set of real world activities 220a. The associated information 222a may additionally include one or more rules 229a. Examples of rules include rules to proceed to a higher level, scoring method in each level and time assigned to each level to reach the end of the level, among others.

The real world activity 220a may include plurality of levels. One or more of the levels of real world activity 220a may be directed at correcting the first defective brain wirings 213a by rewiring the brain to enable individuals to focus on the successful completion of a task 219a. Further, one or more of the levels of real world activity 220a may be directed at correcting the second defective brain wirings 213b by rewiring the brain to enable individuals to weigh between delays in a task and the benefits of successful completion of a task 225a.

The real world activity 220a may be presented to the user after the user has participated in Game 204a at least to a predefined extent. In another embodiment, real world activity 220a may be presented to the user after the user has participated in Game 204b at least to a predefined extent. In yet another embodiment, real world activity 220a may be presented to the user after the user has participated in both the games Game 204a and Game 204b at least to a predefined extent.

One or more levels of the real world activities 220a may be presented to the user after the user has at least participated in one or more games to a predefined extent that attempts to rewire 219a the first defective brain wiring 213a. Similarly, one or more levels of the real world activities 220 may be presented to the user after the user has at least participated in one or more games to a predefined extent that attempts to rewire 225a the first defective brain wiring 213b. As an example, levels 1 and 2 of real world activities are directed at rewiring the first defective brain wiring 213a, and levels 3, 4 and 5 of real world activities are directed at rewiring the second defective brain wiring 213b.

Each level of the real world activity 220a may have an editable option where users can edit what is written and do what they think is feasible for that day. Whatever is written should be saved as that alternative and will show up 5 times later. In a first level, the activity module 200 may provide instructions 227a, to choose a quiet place to sit in and close one's eyes and imagine in detail what is shown, which may include:
Imagine a situation where, you are standing in a line, in a grocery store and the person in front of you has a lot of items for billing and is paying through coupons, for which the cashier has to bill manually. Instead of getting restless, think of the fact that you have actually finished your shopping and you have all the items that you wanted.
Imagine yourself in a restaurant and ordering your favorite soup which is very hot and you want to taste it. Think about how you can wait patiently to taste your favorite soup without letting your tongue burnt.
Imagine your day-to-day situations where you get impatient. Think about all the reasons why you get impatient and challenge them with your goal of the task. Think about the importance of how you are going to complete the task and about the feelings that you will get after completion of the task.
Imagine a situation where you have to go out for an important work but it is raining heavily and how you are going to be calm and focused towards the completion of the important work.
Imagine you being in a hurry, but there's a sweet slow old lady walking in front of you and how you can deal with this situation without getting impatience.

In a second level the activity module 200 may provide instructions 227a, which may include:
In your daily life, when you are travelling by public transport, try not to internalize the conversations happening, in which you are not involved.
In your daily environment observe all those individuals around you (In real or virtual world) who completes his work on time without getting irritated or feeling impatience. Try to internalize how he/she completes the work. Count those number of people that you see today.
In your daily environment observe all those individuals around you, who gets irritated because of delays in their task and, and see why he is unable to complete a task and feels very irritated and unsettled in doing that task. Count those number of people that you see today.

On a second screen, the user may be provided with a scale and instructions may be provided to the user to enter the number of individuals who filled the above criteria, at the end of the day. Further, a box with numbers which the user can tap on may also be provided.

In a third level, the activity module 200 may show the tasks listed below and also provide instructions 227a, which may include:
Today go to your favorite restaurant when you are hungry and wait there for 10 minutes without ordering your food and then order.
Go to a slow service restaurant and have a dinner or lunch over there.
Arrange a social gathering or attend a social gathering where you have to reach 10 minutes earlier than the specified time and wait for everyone to come.
Pick an important task which you were trying to put off for sometime, because of distractions that you would face while doing it. Try to successfully complete that task by not focusing on the delays.
Go to a shopping complex or grocery store on a Saturday or Sunday when its crowded and buy your necessary items from there.

A box with numbers which the user can tap on may be provided. The users may be instructed to tap on the number in the below box which indicates how many displeasing tasks the users have finished that day.

In a fourth level, the activity module 200 may provide instructions 227a, which may include:
Today go to your favorite restaurant when you are hungry and wait there for 20 minutes without ordering your food and then order. It would therefore be important for you to focus on how you could successfully complete this task and don't think about the delays you would face while waiting
Take up several tasks, which you are required to do within a specific time period. Focus on how you could successfully finish doing all the tasks one by one without shifting tasks even if you face delays while doing.
Learn any new instrument, or any thing which is required/important in your life and rehearse your ability of successfully completing a task.

By the end of the day, the user may be instructed to rate his level of satisfaction after completion of the task (1 being low level of satisfaction and 10 being the high level of satisfaction.)

In a fifth level, the activity module 200 may provide instructions 227a to mentor another individual who is impatient (and who wants to change) and guide them on the skills that you have learned. This person could be your friend/family member or colleague.

Referring to FIG. 4B, with regards to laziness 214b, the real world activities 220b or sets of real world activities 220b (may be referred by numeral 220b) is used by the activity module 200 based on the brain rewiring 219b, 225b, which the real world activity 220b is capable of achieving.

Each real world activity 220b may include associated information 222b. As an example, a real world activity may be capable of achieving more than one type of brain rewiring. Alternatively, one type of rewiring may be achieved through one or more real world activities. Each real world activity 220b includes data indicating the brain rewiring(s) 219b, 225b it is capable of achieving, so that the activity module 200 can opt to present a choice of one or more real world activities 220b, which has the capability to achieve the brain rewiring, which the activity module 200 is attempting to achieve.

The associated information 222b may further include instructions 227b to be followed by the user to perform the real world activity 220b or a set of real world activities 220b. The associated information 222b may additionally include one or more rules 229b. Examples of rules include rules to proceed to a higher level, scoring method in each level and time assigned to each level to reach the end of the level, among others.

The real world activity 220b may include plurality of levels. One or more of the levels of real world activity 220b may be directed at correcting the first defective brain wirings 215a by rewiring the brain to enable individuals to think more about the rewards of a task 219b. Further, one or more of the levels of real world activity 220b may be directed at correcting the second defective brain wirings 215b by rewiring the brain to enable individuals to weigh between the efforts required and rewards of a task 225b.

The real world activity 220b may be presented to the user after the user has participated in Game 204c at least to a predefined extent. In another embodiment, real world activity 220b may be presented to the user after the user has participated in Game 204d at least to a predefined extent. In yet another embodiment, real world activity 220b may be presented to the user after the user has participated in both the games Game 204c and Game 204d at least to a predefined extent.

One or more levels of the real world activities 220b may be presented to the user after the user has at least participated in one or more games to a predefined extent that attempts to rewire 219b the first defective brain wiring 215a. Similarly, one or more levels of the real world activities 220b may be presented to the user after the user has at least participated in one or more games to a predefined extent that attempts to rewire 225b the first defective brain wiring 215b. As an example, levels 1 and 2 of real world activities are directed at rewiring the first defective brain wiring 215a, and levels 3, 4 and 5 of real world activities are directed at rewiring the second defective brain wiring 215b.

Each level of the real world activity 220b may have an editable option where users can edit what is written and do what they think is feasible for that day. Whatever is written should be saved as that alternative and will show up 5 times later. In a first level, the activity module 200 may provide instructions 227b, to choose a quiet place to sit in and close one's eyes and imagine in detail what is shown, which may include:
Imagine yourself completing a task that you have been putting off doing. Visualize you working on that task with all energy, enthusiasm and ease. Imagine you being able to finish the task and reflect on the benefits of completing the task.
Close your eyes and visualize that you are cleaning your house and organizing your physical surroundings. In your mind clearly state the intention of doing it and think about the rewards that you will get in return.
Close your eyes and visualize about a task that you feel is difficult to do. Imagine yourself working on that task and feel the satisfaction that you will get after completion.

The activity module 200 is configured to display the above options sequentially and to the user. Further, audio may be enabled for this activity.

In a second level the activity module 200 may provide instructions 227b, which may include:
In your daily environment, observe those individuals who are not lazy. Notice the task they do and how they carry them out. Recognize too that how are they willing to work hard for things that truly matter to them. Count those numbers of people that you see today.
In your daily environment, observe those individuals who are lazy. Notice how they spend time without doing anything and think about the benefits that they are losing by not doing any task. Count those numbers of people that you see today.
In your daily environment, observe those individuals who are very enthusiastic and hard working. Observe the way they carry out a task and also recognize that however difficult a task is they value it and they try to do it. Count those numbers of people that you see today.

On a second screen, the user may be provided with instructions to enter the number of individuals who filled the above criteria, at the end of the day. Further, a box with numbers which the user can tap on may also be provided.

In a third level, the activity module 200 may provide instructions 227b, which may include:
Start your day with mild exercise at least for 15 mins today and feel the freshness and positivity.
Today surprise yourself or your loved ones by cooking. Cooking involves many steps so breakdown your work into simpler task and execute it.
Today clean your house and organize your physical surroundings. You will naturally feel motivated to be more productive and active in your day.
Pick a task which is very important for you to complete today. Break the task into two halves, then share one half of the task with someone who is close to you. You should now believe in yourself and feel more confident and happy as a person.
When a task is assigned to you by someone else, try to break down the task into smaller bits so you can feel you are doing smaller chunks of work. After breaking down the task, execute it in a way how you want others to do it.

On a second screen, the user may be provided with options to tap on the number in the below box which indicates how many displeasing tasks the user has finished on that particular day. A box with numbers which the user can tap on may also be provided.

In a fourth level, the activity module 200 may provide instructions 227b, which may include:
Pick a vital task that is important and have benefits for your future and is a part of your goal, but you have been putting off doing that task because of your laziness. Plan and break down the task into smaller tasks and execute it step by step. After completion of a small part of the task, reward yourself by doing the work that you like.

By the end of the day, the user may be instructed to rate his level of satisfaction after completion of the task (1 being low level of satisfaction and 10 being the high level of satisfaction).

In a fifth level, the activity module 200 may provide instructions 227b mentor another individual who is lazy (and who wants to change) and guide them on the skills that you have learned. This person could be your friend/family member or colleague.

Referring to FIG. 4C, with regards to low trust issues 214c, the real world activities 220c or sets of real world activities 220c (may be referred by numeral 220c) is used by the activity module 200 based on the brain rewiring 219c, 225c, which the real world activity 220c is capable of achieving.

Each real world activity 220c may include associated information 222c. As an example, a real world activity may be capable of achieving more than one type of brain rewiring. Alternatively, one type of rewiring may be achieved through one or more real world activities. Each real world activity 220c includes data indicating the brain rewiring(s) 219c, 225c it is capable of achieving, so that the activity module 200 can opt to present a choice of one or more real world activities 220c, which has the capability to achieve the brain rewiring, which the activity module 200 is attempting to achieve.

The associated information 222c may further include instructions 227c to be followed by the user to perform the real world activity 220c or a set of real world activities 220c. The associated information 222c may additionally include one or more rules 229c. Examples of rules include rules to proceed to a higher level, scoring method in each level and time assigned to each level to reach the end of the level, among others.

The real world activity 220c may include plurality of levels. One or more of the levels of real world activity 220c may be directed at correcting the first defective brain wirings 217a by rewiring the brain to enable individuals to give priority to information that agree with the expressed thoughts/words/actions of another individual 219c. Further, one or more of the levels of real world activity 220c may be directed at correcting the second defective brain wirings 215b by rewiring the brain to enable individuals to weigh between the information that conflicts or agree with the expressed thoughts/words/actions of another individual 225c.

The real world activity 220c may be presented to the user after the user has participated in Game 204e at least to a predefined extent. In another embodiment, real world activity 220c may be presented to the user after the user has participated in Game 204f at least to a predefined extent. In yet another embodiment, real world activity 220c may be presented to the user after the user has participated in both the games Game 204e and Game 204f at least to a predefined extent.

One or more levels of the real world activities 220c may be presented to the user after the user has at least participated in one or more games to a predefined extent that attempts to rewire 219c the first defective brain wiring 217a. Similarly, one or more levels of the real world activities 220c may be presented to the user after the user has at least participated in one or more games to a predefined extent that attempts to rewire 225c the first defective brain wiring 217b. As an example, levels 1 and 2 of real world activities are directed at rewiring the first defective brain wiring 217a, and levels 3, 4 and 5 of real world activities are directed at rewiring the second defective brain wiring 217b.

Each level of the real world activity 220c may have an editable option where users can edit what is written and do what they think is feasible for that day. Whatever is written should be saved as that alternative and will show up 5 times later. In a first level, the activity module 200 may provide instructions 227c, to choose a quiet place to sit in and close one's eyes and imagine in detail what is shown, which may include:
Imagine a situation where one of your friends borrowed money from you. Visualize that he/she was in need of the money and that he/she will be returning the amount in few days. Think about you being able to trust your friend to repay your money. Imagine that you are able to trust other people in your daily life and you being happy about it.
Imagine a situation where your neighbor asks for your vehicle for an important reason. Visualize that you give your vehicle to your neighbor without suspecting if he/she will be able to maintain it well. Imagine that you trust your neighbor with your vehicle and think about him/her returning your vehicle in good condition along with a thank you note.
Imagine a situation where your spouse has become busy lately. Visualize that he/she has a lot of commitments at his/her workplace. Imagine you trusting the intentions of your partner and him/her being loyal to you despite being busy.
Imagine a situation where your business competitor invites you for dinner. Visualize that he/she is trying to establish a social contact with you and just wants to get to know you better. Imagine that you have a good time with him/her and you feeling happy about meeting your competitor. Visualize you trusting the intentions of the business competitor.
Imagine a situation where you witness your partner chatting with a person. Visualize that the person was helping your partner with his/her new venture. Imagine you trusting the intentions of your partner and him/her being loyal to you despite him/her talking to other people.

In a second level, the activity module 200 may provide instructions 227c, which may include:
In your daily environment, read stories of successful couples who have been together despite a lot of struggles in their life. Recognize that such relationships have mainly worked as both the partners instill a lot of trust in each other and understand that their partner's intentions are genuine. Look for at least two of such articles/writings today.
In your environment, look for any group effort, for example watch an aerial act and observe how people trust each other and place confidence in them while performing as a group. Count the number of such group efforts that you see today.
Observe how two people (for example, patient-doctor, boss-employee, colleagues) trust each other to carry out a deal/any kind of work in their daily life. Notice that each of these people believe that the other person will work towards their best interest. Count those numbers of people that you see today.
In your daily environment, observe how people believe stranger's suggestions to reach a particular destination. Notice that the person asking for the directions relies on the stranger to give him the correct directions. Count the number of those people you can see today.
In your daily environment, observe how people buy expensive products (for example, properties/vehicles) by trusting the quality of what they are buying. Notice how they place trust in the suggestions of the seller. Count the number of those people you can see today.

In a third level, the activity module 200 may provide instructions 227c, which may include:
Today, ask your friend to withdraw a small amount of money for you from the nearby ATM. Before doing this, think about the information that makes this friend of yours reliable. Notice all the positive aspects of this person, which makes you trust him/her.
Today, ask your friend to do a small assignment (which is of least importance) of yours. Think about why this friend of yours will be able to complete this assignment. Notice all the aspects in this person (E.g. the person being diligent, hardworking, knowledgeable) which would make him complete the assignment given to him.
Today, talk to your close one and request him to park your vehicle for a day or two in his premises. Think about the reasons why you can give him your vehicle. Reflect on the aspects of this person which make him trustworthy and dependable to lend your bike.
Request your close one to pick you from home at a particular time. Think about why you would rely on this person to pick you up by focusing on aspects of this person that make him trustworthy.
Ask your friend to buy anything that does not cost much for you (for example, stationery, footwear) and don't cross check the quality or the price for the same. Think about the item being fine for you and also think about aspects of this person that makes his/her intentions genuine. Think about you being happy with the product.

In a fourth level, the activity module 200 may provide instructions 227c, which may include:
Today, go to a shop to buy something, after collecting the change, don't count. Think about the change being exact and do not check.
Today, try to reach a destination with the help of people giving you directions. Think about the directions being correct and how the people giving you directions are genuinely trying to help you.
Today, ask a stranger to recommend a restaurant/a place to shop for a special occasion. Think about the suggestion being very good and also reflect on how the person giving you the suggestions is genuinely trying to help you out. Think about you being happy and satisfied with the suggestions.
Today, leave your bags/luggage open in on your desk at work instead of carrying it around in the office. Look at other people who are leaving their bags in the office without any hesitation. Think about your bags and all your belongings inside it being safe. Think about you being able to trust the people around you to be genuine.
Today, try a new website for a movie/food delivery/restaurant and so on. Look at the number of visitors on the page and also read the reviews/testimonials from people who have ordered from the website. Think about you receiving the product/tickets/food you order in good condition. Think about you being able to trust the website for your future orders as well.

In a fifth level, the activity module 200 may provide instructions 227c to mentor a person with similar trait as yours with whatever skills you have learnt in the course of this program. This person can be a family member, colleague or a friend in your circle.

In an embodiment, the action database 206 further includes plurality of physical actions, mind actions and dietary actions, one or more of which may be presented to a user who is trying to overcome impatience 214a.

Example of physical actions includes one or more physical activities, such as exercises and physical postures, among others. Example of mind actions may include meditation. Example of dietary actions may include adding specific food to one's diet or deleting specific food from the diet. As a further example, drinking black tea may be a dietary action and cutting down on rice consumption may be another dietary action.

### Logging Module 208

In an embodiment, the logging module 208 enables logging of the activities (ex: games, real world activities and other actions) performed by the user. The logging module 208 may record information corresponding to the activities performed by the user. The information may include one or more of, time of performance, date of performance, quantum of performance, success or failure consequent to an attempt to perform, and extent of success in performing the action, among others. The user may provide input that an activity has been performed. Such input may be used to log the activity in the logging module 208. Alternatively, the logging module 208 may be configured to automatically log the performance of an activity upon detection that the activity has been performed.

### Assessment Module 210

The assessment module 210 of the activity module 200 is configured to determine the performance of a user in each activity the user performs. The assessment module 210 may determine the user's score for each game and at each level in a game based on the log available in the logging module 208. Further, the assessment module 210 analyzes performance of the user in the real world activities and determines scores of each level of real world activity based on the log that is present in the logging module 208. The assessment module 210 may also determine status of the one or more behavioral trait 214 or the brain wiring causing the trait, after engaging in the activities, based on performance of activities suggested by the activity module 200.

### User Interface Module 212

The user interface module 212 may be configured to receive input from the user and display content to the user. The content displayed, can be, as an example, games, images, instructions, rules, information, haptic feedback and sound, among others.

### V. Method for Overcoming Impatience, Laziness and Low Trust Issues

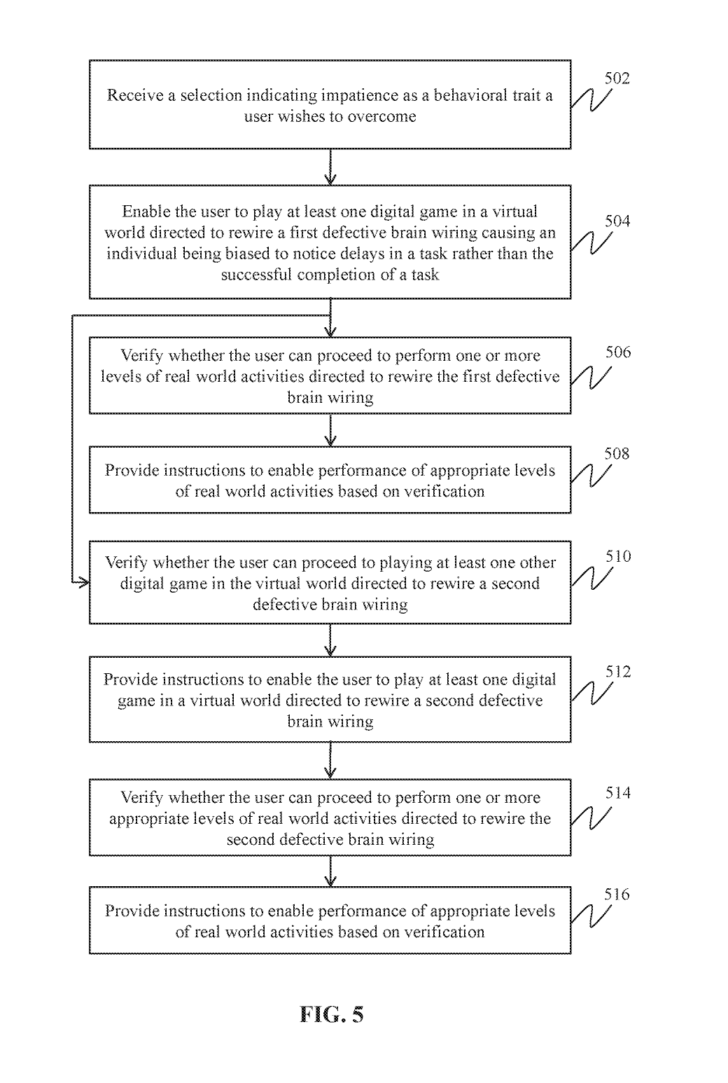

Now referring more particularly to FIG. 5, a method is provided for overcoming impatience 214a. A selection indicating impatience 214a as a behavioral trait which a user wishes to overcome is received at step 502. At step 504, a user is enabled to participate/play in at least one digital game 204a which is played in a virtual world. The digital game 204a is instrumental in rewiring 219a, a first defective brain wiring 213a, whose symptom is exhibition of impatience 214a. At step 506, verification is made to determine whether the user can proceed to perform one or more appropriate levels of real world activities 220a directed to rewire the first defective wiring 213a. In case it is determined that user can proceed, then at step 508, instructions are provided to enable the user to perform appropriate real world activity/activities 220a. Preferably, the user is allowed to perform or instructed to begin performing appropriate real world activities 220a upon participating in the digital game 204a at least to a predefined extent, which is determined based on the desired rewiring. The real world activity 220a is instrumental in rewiring 219a the first defective brain wiring 215a, whose symptom is exhibition of impatience 214a.

At step 510, verification is made to determine whether the user can proceed to playing at least one other digital game 204b in the virtual world directed to rewire a second defective brain wiring 213b. In case it is determined that user can proceed, then at step 512 the user is enabled to participate/play digital games 204b, which is played in a virtual world. The digital game 204b is instrumental in rewiring 225a the second defective brain wiring 213b, whose symptom is exhibition of impatience 214a. Preferably, the user is allowed to proceed to playing at least one other digital game 204b upon participating in the game(s) instrumental in rewiring 219a the first defective wiring 213a at least to a predefined extent, which is determined based on the desired rewiring.

At step 514, verification is made to determine whether the user can proceed to perform one or more appropriate levels of real world activities 220a. In case it is determined that user can proceed, then at step 516, instructions are provided to the user to enable the user to perform the appropriate levels of real world activity/activities 220a. Preferably, the user is allowed to perform or instructed to begin performing appropriate real world activities 220a upon participating in the digital game(s) 204b at least to a predefined extent, which is determined based on the desired rewiring. The real world activity 220 is instrumental in rewiring 225a the second defective brain wiring 213b, whose symptom is exhibition of impatience 214a.

Referring to the step (502) of receiving a selection indicating impatience 214a, the user may be provided an option to select a behavioral trait that he would like to overcome. The activity module 200 may provide or recommend an option to select at least one weak behavioral trait to work on. The user may select at least one behavioral trait 214 that the user thinks he needs to work on, from a list of behavioral traits that may be displayed to the user via the user interface module 212. Alternatively, the user may input answers in response to a set of questions displayed to the user, which may determine what type of weak behavioral trait 214 the user may have. Upon selection of impatience 214a, the activity module 200 may display a list 213d of other behavioral traits that can be confused with impatience 214a, so that the user can select a more appropriate behavioral trait 214, which he desires to work on. The activity module 200 may further display the information corresponding to the brain wirings (defect) 213a, 213b causing the behavioral trait 214. The first defective brain wiring 213a causes bias to notice delays in a task rather than the successful completion of a task. The second defective brain wiring 213b causes inability to weigh between the delays in a task and the benefits of successful completion of a task.

The activity module 200 may additionally display information about impact 213c of impatience 214a to the user. In addition, the activity module 200 may display information corresponding to the brain rewiring 219a, 225a that the activity module 200 is attempting to achieve to overcome impatience 214a. Rewiring 219a of the first defective brain wiring 213a results in individuals' increased ability to focus on the successful completion of a task. Rewiring 225a of the second defective brain wiring 213b results in increased ability to weigh between delays in a task and the benefits of successful completion of a task.

Furthermore, the activity module 200 may display the information corresponding to the causes (genetic or environmental) that resulted in the defective brain wirings (defect) 213a, 213b.

Referring to the step (504) of enabling the user to play at least one digital game in the virtual world directed to rewire the first defective brain wiring 213a, the activity module 200 may select one or more digital games based on the capability of the digital games to achieve the desired brain rewiring 219a.

The activity module 200 may provide a choice (one or more games) of games, from which the user may select. The activity module 200 may even indicate the effectiveness of each of the games in achieving the desired brain rewiring 219a or an aspect of rewiring.

In an embodiment, the activity module 200 is configured to recommend a plurality of games 204, wherein the recommendation indicates each of the games' 204 effectiveness to achieve the desired brain rewiring 219a or an aspect of rewiring.

The activity module 200 allows the user to play the selected game. The logging module 208 may log the performance of the user. The assessment module 210 may determine the performance scores using the log in the logging module 208. Further, based on the respective rules 223a, the user is either allowed or denied access to other levels of the game 204.

Referring to step 506, the activity module 200 verifies whether the user can proceed to perform one or more levels of real world activities 220a. Preferably, the activity module 200 recommends appropriate levels of real world activities 220a, after the user has performed to a desired extent in the digital game(s) 204. Desired extent of performance can be, as an example, levels completed, score reached and duration over which the game 204 was played.

In an embodiment, the activity module 200 recommends (step 508) participating in one or more levels of real world activity 220a or a part thereof, after the user has performed to a desired extent in the digital game 204a. Likewise, the activity module 200 may recommend participating in one or more levels of real world activity 220a or a part thereof, after the user has performed to a desired extent in the digital game 204b. Desired extent of performance can be, as an example, levels completed, score reached and duration over which the game(s) were played.

In an embodiment, the activity module 200 recommends participating in a level or part of real world activity (ex: level of real world activity 220a) after the user has performed to a desired extent in a level of the digital game (ex: level of digital game 204a), wherein the level of the digital game prepares the user to participate in the level or part of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

The logging module 208 may log the performance of the user. The assessment module 210 may determine the performance scores using the log in the logging module 208. Further, based on the rules 229a, the user is either allowed or denied access to other levels of the real world activities or sets of real world activities.

Referring to step 510, the activity module 200 verifies whether the user can proceed to playing at least one or more other digital games in the virtual world directed to rewire the second defective brain wiring 213b.

In an embodiment, the activity module 200 recommends participating in digital games directed to rewire the second defective brain wiring 213b after the user has performed to a desired extent in the digital game(s) directed to rewire the first defective brain wiring 213a.

In another embodiment, the activity module 200 recommends participating in digital games directed to rewire the second defective brain wiring 213b after the user has performed to a desired extent in the digital game(s) and one or more levels of real world activity/activities 220a directed to rewire the first defective brain wiring 213a.

The activity module 200, based on the verification, enables (step 512) the user to play/participate in at least one other digital game 204b in the virtual world directed to rewire the second defective brain wiring.

Referring to step 514, the activity module 200 verifies whether the user can proceed to perform one or more appropriate levels of real world activity/activities 220a directed to rewire 225a the second defective brain wiring 213b. In an embodiment, the activity module 200 recommends (steps 514, 516) participating in real world activity 220a or part thereof after the user has performed to a desired extent in the digital game 204b.

In another embodiment, the activity module 200 recommends participating in digital game 204b after the user has performed to a desired extent in a level of the digital game 204a.

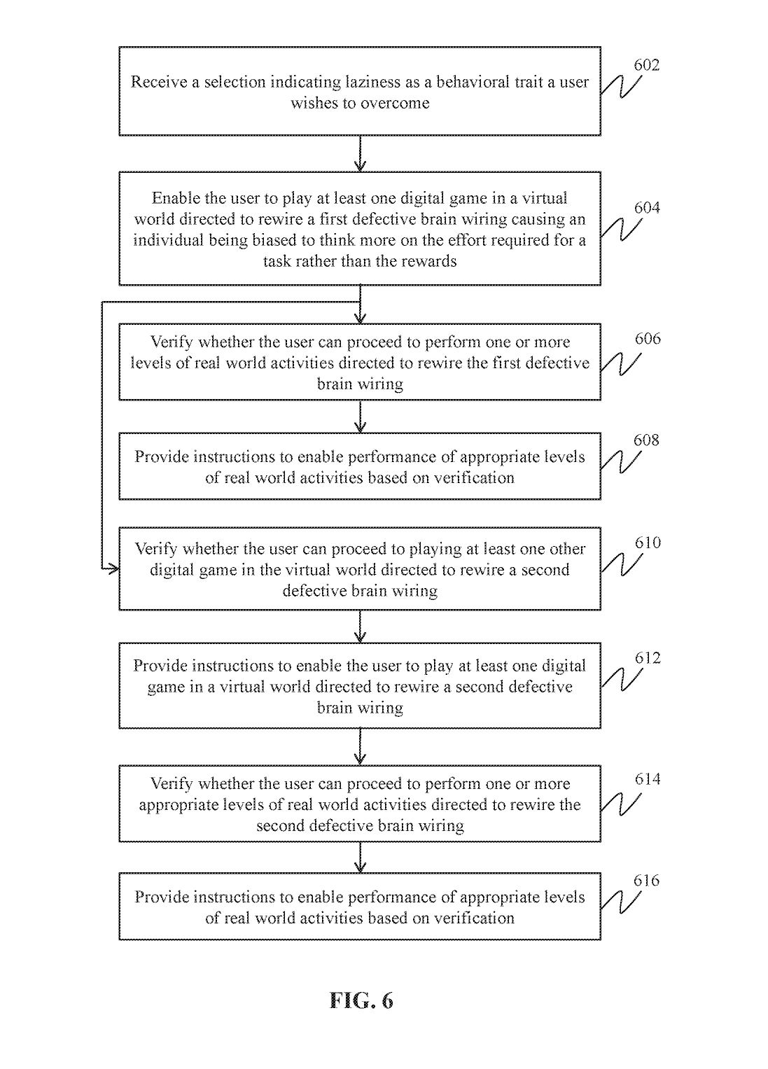

Now referring more particularly to FIG. 6, a method is provided for overcoming laziness 214b. A selection indicating laziness 214b as a behavioral trait which a user wishes to overcome is received at step 602. At step 604, a user is enabled to participate/play in at least one digital game 204c which is played in a virtual world. The digital game 204c is instrumental in rewiring 219b, a first defective brain wiring 215a, whose symptom is exhibition of impatience 214a. At step 606, verification is made to determine whether the user can proceed to perform one or more appropriate levels of real world activities 220b directed to rewire the first defective wiring 215a. In case it is determined that user can proceed, then at step 608, instructions are provided to enable the user to perform appropriate real world activity/activities 220b. Preferably, the user is allowed to perform or instructed to begin performing appropriate real world activities 220b upon participating in the digital game 204c at least to a predefined extent, which is determined based on the desired rewiring. The real world activity 220b is instrumental in rewiring 219b the first defective brain wiring 215a, whose symptom is exhibition of laziness 214b.

At step 610, verification is made to determine whether the user can proceed to playing at least one other digital game 204d in the virtual world directed to rewire a second defective brain wiring 215b. In case it is determined that user can proceed, then at step 612 the user is enabled to participate/play digital games 204d, which is played in a virtual world. The digital game 204d is instrumental in rewiring 225b the second defective brain wiring 215b, whose symptom is exhibition of laziness 214b. Preferably, the user is allowed to proceed to playing at least one other digital game 204d upon participating in the game(s) instrumental in rewiring 219b the first defective wiring 215a at least to a predefined extent, which is determined based on the desired rewiring.

At step 614, verification is made to determine whether the user can proceed to perform one or more appropriate levels of real world activities 220b. In case it is determined that user can proceed, then at step 616, instructions are provided to the user to enable the user to perform the appropriate levels of real world activity/activities 220b. Preferably, the user is allowed to perform or instructed to begin performing appropriate real world activities 220b upon participating in the digital game(s) 204d at least to a predefined extent, which is determined based on the desired rewiring. The real world activity 220d is instrumental in rewiring 225b the second defective brain wiring 215b, whose symptom is exhibition of laziness 214b.

Upon selection of laziness 214b, the activity module 200 may display a list 215d of other behavioural traits that can be confused with laziness 214b, so that the user can select a more appropriate behavioral trait 214, which he desires to work on. The activity module 200 may further display the information corresponding to the brain wirings (defect) 215a, 215b causing the behavioral trait 214. The first defective brain wiring 215a causes bias to think more on the effort required for a task rather than the rewards. The second defective brain wiring 215b causes inability to weigh between the efforts required and rewards of a task.

The activity module 200 may additionally display information about impact 215c of laziness 214b to the user. In addition, the activity module 200 may display information corresponding to the brain rewiring 219b, 225b that the activity module 200 is attempting to achieve to overcome laziness 214b. Rewiring 219b of the first defective brain wiring 215a results in individuals' increased ability to think more about the rewards of a task. Rewiring 225b of the second defective brain wiring 215b results in increased ability to weigh between the efforts required and rewards of a task.

Furthermore, the activity module 200 may display the information corresponding to the causes (genetic or environmental) that resulted in the defective brain wirings (defect) 215a, 215b.

Referring to the step (604) of enabling the user to play at least one digital game in the virtual world directed to rewire the first defective brain wiring 215a, the activity module 200 may select one or more digital games based on the capability of the digital games to achieve the desired brain rewiring 219b.

Referring to step 606, the activity module 200 verifies whether the user can proceed to perform one or more levels of real world activities 220b. Preferably, the activity module 200 recommends appropriate levels of real world activities 220b after the user has performed to a desired extent in the digital game(s) 204c and/or 204d. Desired extent of performance can be, as an example, levels completed, score reached and duration over which the game was played.

In an embodiment, the activity module 200 recommends (step 608) participating in one or more levels of real world activity 220b or a part thereof, after the user has performed to a desired extent in the digital game 204c. Likewise, the activity module 200 may recommend participating in one or more levels of real world activity 220b or a part thereof, after the user has performed to a desired extent in the digital game 204d. Desired extent of performance can be, as an example, levels completed, score reached and duration over which the game(s) were played.

In an embodiment, the activity module 200 recommends participating in a level or part of real world activity (ex: level of real world activity 220b) after the user has performed to a desired extent in a level of the digital game (ex: level of digital game 204c), wherein the level of the digital game prepares the user to participate in the level or part of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

Referring to step 610, the activity module 200 verifies whether the user can proceed to playing at least one or more other digital games in the virtual world directed to rewire the second defective brain wiring 215b.

In an embodiment, the activity module 200 recommends participating in digital games directed to rewire the second defective brain wiring 215b after the user has performed to a desired extent in the digital game(s) directed to rewire the first defective brain wiring 215a.

In another embodiment, the activity module 200 recommends participating in digital games directed to rewire the second defective brain wiring 215b after the user has performed to a desired extent in the digital game(s) and one or more levels of real world activity/activities 220b directed to rewire the first defective brain wiring 215a.

The activity module 200, based on the verification, enables (step 612) the user to play/participate in at least one other digital game 204d in the virtual world directed to rewire the second defective brain wiring.

Referring to step 614, the activity module 200 verifies whether the user can proceed to perform one or more appropriate levels of real world activity/activities 220b directed to rewire 225b the second defective brain wiring 215b. In an embodiment, the activity module 200 recommends (steps 614, 616) participating in real world activity 220b or part thereof after the user has performed to a desired extent in the digital game 204d.

In another embodiment, the activity module 200 recommends participating in digital game 204d after the user has performed to a desired extent in a level of the digital game 204c.

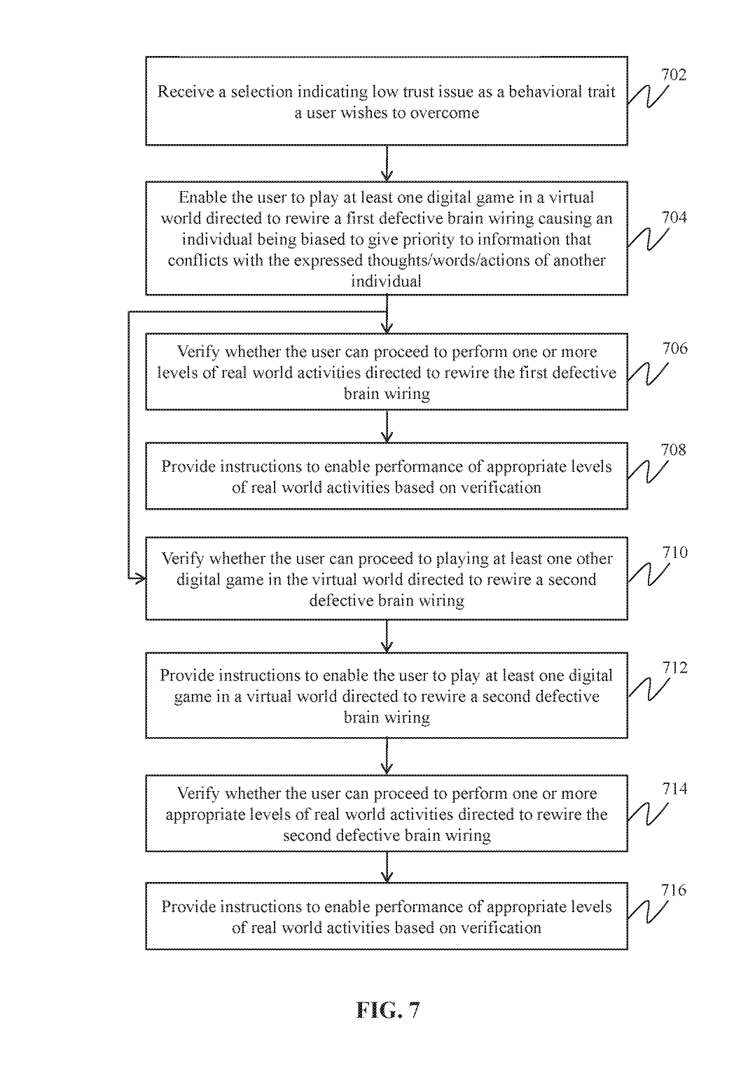

Now referring more particularly to FIG. 7, a method is provided for overcoming low trust issues 214c. A selection indicating low trust issues 214c as a behavioral trait which a user wishes to overcome is received at step 702. At step 704, a user is enabled to participate/play in at least one digital game 204e which is played in a virtual world. The digital game 204e is instrumental in rewiring 219c, a first defective brain wiring 217a, whose symptom is exhibition of low trust issues 214c. At step 706, verification is made to determine whether the user can proceed to perform one or more appropriate levels of real world activities 220c directed to rewire the first defective wiring 217a. In case it is determined that user can proceed, then at step 708, instructions are provided to enable the user to perform appropriate real world activity/activities 220c. Preferably, the user is allowed to perform or instructed to begin performing appropriate real world activities 220c upon participating in the digital game 204e at least to a predefined extent, which is determined based on the desired rewiring. The real world activity 220c is instrumental in rewiring 219c the first defective brain wiring 217a, whose symptom is exhibition of low trust issues 214c.

At step 710, verification is made to determine whether the user can proceed to playing at least one other digital game 204f in the virtual world directed to rewire a second defective brain wiring 217b. In case it is determined that user can proceed, then at step 712 the user is enabled to participate/play digital games 204f, which is played in a virtual world. The digital game 204f is instrumental in rewiring 225c the second defective brain wiring 217b, whose symptom is exhibition of low trust issues 214c. Preferably, the user is allowed to proceed to playing at least one other digital game 204f upon participating in the game(s) instrumental in rewiring 219c the first defective wiring 217a at least to a predefined extent, which is determined based on the desired rewiring.

At step 714, verification is made to determine whether the user can proceed to perform one or more appropriate levels of real world activities 220c. In case it is determined that user can proceed, then at step 716, instructions are provided to the user to enable the user to perform the appropriate levels of real world activity/activities 220c. Preferably, the user is allowed to perform or instructed to begin performing appropriate real world activities 220c upon participating in the digital game(s) 204f at least to a predefined extent, which is determined based on the desired rewiring. The real world activity 220c is instrumental in rewiring 225c the second defective brain wiring 217b, whose symptom is exhibition of low trust issues 214c.

Upon selection of low trust issues 214c, the activity module 200 may display a list 217d of other behavioral traits that can be confused with low trust issues 214c, so that the user can select a more appropriate behavioral trait 214, which he desires to work on. The activity module 200 may further display the information corresponding to the brain wirings (defect) 217a, 217b causing the behavioral trait 214. The first defective brain wiring 217a causes bias to give priority to information that conflict with the expressed thoughts/words/actions of another individual. The second defective brain wiring 217b causes inability to weigh between the information that conflicts or agree with the expressed thoughts/words/actions of another individual.

The activity module 200 may additionally display information about impact 217c of low trust issues 214c to the user. In addition, the activity module 200 may display information corresponding to the brain rewiring 219c, 225c that the activity module 200 is attempting to achieve to overcome low trust issues 214c. Rewiring 219c of the first defective brain wiring 217a results in individuals' increased ability to give priority to information that agree with the expressed thoughts/words/actions of another individual. Rewiring 225c of the second defective brain wiring 217b results in increased ability to weigh between the information that conflicts or agree with the expressed thoughts/words/actions of another individual.

Furthermore, the activity module 200 may display the information corresponding to the causes (genetic or environmental) that resulted in the defective brain wirings (defect) 217a, 217b.

Referring to the step (704) of enabling the user to play at least one digital game in the virtual world directed to rewire the first defective brain wiring 217a, the activity module 200 may select one or more digital games based on the capability of the digital games to achieve the desired brain rewiring 219c.

Referring to step 706, the activity module 200 verifies whether the user can proceed to perform one or more levels of real world activities 220c. Preferably, the activity module 200 recommends appropriate levels of real world activities 220c after the user has performed to a desired extent in the digital game(s) 204e and/or 204f. Desired extent of performance can be, as an example, levels completed, score reached and duration over which the game was played.

In an embodiment, the activity module 200 recommends (step 708) participating in one or more levels of real world activity 220c or a part thereof, after the user has performed to a desired extent in the digital game 204e. Likewise, the activity module 200 may recommend participating in one or more levels of real world activity 220c or a part thereof, after the user has performed to a desired extent in the digital game 204f Desired extent of performance can be, as an example, levels completed, score reached and duration over which the game(s) were played.

In an embodiment, the activity module 200 recommends participating in a level or part of real world activity (ex: level of real world activity 220c) after the user has performed to a desired extent in a level of the digital game (ex: level of digital game 204e), wherein the level of the digital game prepares the user to participate in the level or part of the real world activity.

In an embodiment, the activity module 200 is configured to recommend a plurality of real world activities or sets of real world activities 220, wherein the recommendation indicates each of the real world activities' or sets of real world activities' 220 effectiveness to achieve the desired brain rewiring.

Referring to step 710, the activity module 200 verifies whether the user can proceed to playing at least one or more other digital games in the virtual world directed to rewire the second defective brain wiring 217b.

In an embodiment, the activity module 200 recommends participating in digital games directed to rewire the second defective brain wiring 217b after the user has performed to a desired extent in the digital game(s) directed to rewire the first defective brain wiring 217a.

In another embodiment, the activity module 200 recommends participating in digital games directed to rewire the second defective brain wiring 215b after the user has performed to a desired extent in the digital game(s) and one or more levels of real world activity/activities 220c directed to rewire the first defective brain wiring 217a.

The activity module 200, based on the verification, enables (step 712) the user to play/participate in at least one other digital game 204f in the virtual world directed to rewire the second defective brain wiring.

Referring to step 714, the activity module 200 verifies whether the user can proceed to perform one or more appropriate levels of real world activity/activities 220b directed to rewire 225c the second defective brain wiring 217b. In an embodiment, the activity module 200 recommends (steps 714, 716) participating in real world activity 220c or part thereof after the user has performed to a desired extent in the digital game 204f.

In another embodiment, the activity module 200 recommends participating in digital game 204e after the user has performed to a desired extent in a level of the digital game 204f.

Additionally, the activity module 200 may provide instruction to perform mind actions, physical actions and dietary actions.

Each of the physical and dietary actions may have effect on one or more hormones corresponding to one or more traits, among others. While executing the physical action the energy expended in the body is more compared to the energy expended while playing brain game. Similarly, the mind action may involve thinking about the specific trait in a way which may change the structure of the brain by changing the Axons, Receptors and/or the number of Neurons. The dietary action may include consuming specific foods which changes one or more hormone levels.

The real world, mind, physical and dietary activities are carried out in a real environment. Automated instructions are provided as to when and how the activities may have to be carried out. Further, there may be instructions that one or more of the real world activities may have to be carried out simultaneously with the brain games and one or more of the activities may have to be carried out prior to or after engaging in brain game (digital games) and performing to a desired extent.

In an embodiment, upon selecting a behavioral trait, the activity module 200 provides a scale operable by the user to select a position on the scale. The position may be indicative of the user's perception of how impatient or lazy he is or how low trust issues does he have. Improvement in eradication of impatience or laziness or low trust issues resulting from the rewiring of the brain achieved by the performance of the activities (virtual games or real world activities) enabled by the activity module 200 is reflected on the scale. Degradation of improvement in eradication of impatience or laziness or low trust issues resulting from the degradation of the rewiring of the brain due to premature halt in performance of the activities (virtual games or real world activities) enabled by the activity module 200 is also reflected on the scale.

The games and the real world activities change the neural connections in the brain. When these activities are carried out repeatedly, new neural connections are formed (brain plasticity) but if one stops carrying out these activities prematurely then slowly the neural connections die.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling a user to overcome impatience, laziness and low trust issues, the system comprising an activity module configured to:
receive input indicating the desire to overcome at least one of impatience, laziness and low trust issues;
if the input indicates the desire to overcome impatience, then:
enable the user to engage in at least a first activity in a virtual environment, wherein the first activity is directed to rewire a first defective wiring of the brain, wherein the first defective wiring results in an individual being biased to notice delays in a task rather than the successful completion of a task;
enable the user to engage in at least a second activity in the virtual environment, wherein the second activity is directed to rewire a second defective wiring of the brain, wherein the second defective wiring results in inability to weigh between the delays in a task and the benefits of successful completion of a task, wherein symptom of the first and the second defective wirings is impatience;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain;
if the input indicates the desire to overcome laziness, then:
enable the user to engage in at least a first activity in a virtual environment, wherein the first activity is directed to rewire a first defective wiring of the brain, wherein the first defective wiring results in an individual being biased to think more on the effort required for a task rather than the rewards of the task;
enable the user to engage in at least a second activity in the virtual environment, wherein the second activity is directed to rewire a second defective wiring of the brain, wherein the second defective wiring results in inability to weigh between the efforts required and the rewards of a task, wherein symptom of the first and the second defective wirings is laziness;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain; and
if the input indicates the desire to overcome low trust issues, then:
enable the user to engage in at least a first activity in a virtual environment, wherein the first activity is directed to rewire a first defective wiring of the brain, wherein the first defective wiring results in an individual being biased to give priority to information that conflicts with the expressed thoughts/words/actions of another individual;
enable the user to engage in at least a second activity in the virtual environment, wherein the second activity is directed to rewire a second defective wiring of the brain, wherein the second defective wiring results in inability to weigh between the information that conflicts or agree with the expressed thoughts/words/actions of another individual, wherein symptom of the first and the second defective wirings is low trust issues;
provide automated instructions to the user to engage in at least one activity, wherein the one activity is performed in a real world environment, wherein the activity is directed to rewire the first defective wiring of the brain; and
provide automated instructions to the user to engage in yet another activity, wherein the yet another activity is performed in the real world environment, wherein the yet another activity is directed to rewire the second defective wiring of the brain.

2. The system of claim 1, wherein the activities in the virtual environment are digital games.

3. The system of claim 1, wherein the activity module is further configured to provide the automated instructions to engage in the activity directed to rewire the first defective wiring to be performed in the real world environment, after the user has at least participated in the first activity.

4. The system of claim 1, wherein the activity module is further configured to provide the automated instructions to engage in the activity directed to rewire the second defective wiring to be performed in the real world environment, after the user has at least participated in the second activity.

5. The system of claim 1, wherein the activity module is further configured to enable the user to engage in the second activity, after the user has at least participated in the first activity.

6. A method for enabling a user to overcome impatience, the method comprising:
receiving input indicating the desire to overcome at least one of impatience, laziness and low trust issues;
if the input indicates the desire to overcome impatience, then:
enabling the user to engage in at least a first activity in a virtual environment, wherein the first activity is directed to rewire a first defective wiring of the brain, wherein the first defective wiring results in an individual being biased to notice delays in a task rather than the successful completion of a task;
enabling the user to engage in at least a second activity in the virtual environment, wherein the second activity is directed to rewire a second defective wiring of the brain, wherein the second defective wiring results in inability to weigh between the delays in a task and the benefits of successful completion of a task, wherein symptom of the first and the second defective wirings is impatience;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain;
if the input indicates the desire to overcome laziness, then:
enabling the user to engage in at least a first activity in a virtual environment, wherein the first activity is directed to rewire a first defective wiring of the brain, wherein the first defective wiring results in an individual being biased to think more on the effort required for a task rather than the rewards of the task;
enabling the user to engage in at least a second activity in the virtual environment, wherein the second activity is directed to rewire a second defective wiring of the brain, wherein the second defective wiring results in inability to weigh between the efforts required and the rewards of a task, wherein symptom of the first and the second defective wirings is laziness;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain; and
if the input indicates the desire to overcome low trust issues, then:
enabling the user to engage in at least a first activity in a virtual environment, wherein the first activity is directed to rewire a first defective wiring of the brain, wherein the first defective wiring results in an individual being biased to give priority to information that conflicts with the expressed thoughts/words/actions of another individual;
enabling the user to engage in at least a second activity in the virtual environment, wherein the second activity is directed to rewire a second defective wiring of the brain, wherein the second defective wiring results in inability to weigh between the information that conflicts or agree with the expressed thoughts/words/actions of another individual, wherein symptom of the first and the second defective wirings is low trust issues;
providing automated instructions to the user to engage in at least one activity, wherein the one activity is performed in a real world environment, wherein the activity is directed to rewire the first defective wiring of the brain; and
providing automated instructions to the user to engage in yet another activity, wherein the yet another activity is performed in the real world environment, wherein the yet another activity is directed to rewire the second defective wiring of the brain.

7. The method of claim 6, wherein the activities in the virtual environment are digital games.

8. The method of claim 6, wherein the automated instructions to engage in the activity directed to rewire the first defective wiring, to be performed in the real world environment, is provided after the user has at least participated in the first activity.

9. The method of claim 6, wherein the automated instructions to engage in the activity directed to rewire the second defective wirings, to be performed in the real world environment, is provided after the user has at least participated in the second activity.

10. The method of claim 6, wherein the user is enabled to engage in the second activity after the user has at least participated in the first activity.

11. The system of claim 1, wherein
the first activity is directed to rewire the first defective wiring causing impatience to enable the user to increase the user's ability to focus on the successful completion of a task;
the second activity is directed to rewire the second defective wiring causing impatience, to enable the users to weigh between delays in a task and the benefits of successful completion of the task;
the first activity is directed to rewire the first defective wiring causing laziness, to enable users to think more about the rewards of a task;
the second activity is directed to rewire the second defective wiring causing laziness, to enable weighing between the efforts required and rewards of a task;
the first activity is directed to rewire the first defective wiring causing low trust issues, to enable users to give priority to information that agree with the expressed thoughts/words/actions of another individual; and
the second activity is directed to rewire the second defective wiring causing low trust issues, to enable weighing between the information that conflicts or agree with the expressed thoughts/words/actions of another individual.
